(19) United States
(12) Patent Application Publication
(10) Pub. No.: US 2017/0127148 A1
(43) Pub. Date: May 4, 2017

(54) ADVERTISEMENT DELIVERY DEVICE, ADVERTISEMENT DELIVERY SYSTEM, ADVERTISEMENT DELIVERY METHOD, ADVERTISEMENT DELIVERY PROGRAM, CONTENT DISPLAY DEVICE, CONTENT DISPLAY PROGRAM, INFORMATION PROCESSING TERMINAL, AND INFORMATION PROCESSING PROGRAM

(71) Applicant: SHARP KABUSHIKI KAISHA, Sakai City, Osaka (JP)

(72) Inventors: Hiroaki KONDO, Sakai City (JP); Hajime YAMADA, Sakai City (JP); Masaya WATANABE, Sakai City (JP)

(73) Assignee: SHARP KABUSHIKI KAISHA, Sakai City, Osaka (JP)

(21) Appl. No.: 15/317,719

(22) PCT Filed: Jun. 11, 2015
(86) PCT No.: PCT/JP2015/066913

§ 371 Date: Dec. 9, 2016

(30) Foreign Application Priority Data
Jun. 13, 2014 (JP) 2014-122197

(51) Int. Cl. H04N 21/81; H04N 21/254; H04N 21/45; H04N 21/235; H04N 21/258; G06Q 30/02; H04N 21/4627

(52) U.S. Cl. CPC H04N 21/812; G06Q 30/0257; H04N 21/2541; H04N 21/4627; H04N 21/235; H04N 21/258; H04N 21/4532

(57) ABSTRACT

An advertisement delivery device includes a first obtaining unit that obtains viewing-related information indicating a content viewing state on a content display device, a permission/denial information obtaining unit that obtains permission/denial information associating an advertisement delivery condition with information regarding content, and a delivery control unit that cancels, on the basis of the permission/denial information and the viewing-related information, delivery of a delivery candidate advertisement if the content is being viewed on the content display device.

### TECHNICAL FIELD

This invention relates to an advertisement delivery device, an advertisement delivery system, an advertisement delivery method, an advertisement delivery program, a content display device, a content display program, an information processing terminal, and an information processing program.

This application claims priority of Patent Application No. 2014-122197 filed in Japan on Jun. 13, 2014, the entire contents of which are incorporated herein by reference.

### BACKGROUND ART

The use of devices that deliver, for the purpose of sales promotion, advertisements to television receivers and other devices used by users for viewing is widespread.

In relation to this situation, there is known a content delivery method for delivering content from a server to video display devices that have a no-video period over which the video display devices are in the middle of video displaying processing and are not ready to display the desired video (see PTL 1). Specifically, the server delivers content to each operating video display device in advance. An incentive is calculated for the case where the video display device has accepted the delivered content in a viewable state. Then, the delivered content is displayed on the video display device in the no-video period thereof in place of the desired video.

### CITATION LIST

### Patent Document

[PATENT DOCUMENT 1] PTL 1: Japanese Unexamined Patent Application Publication No. 2008-72386

### DISCLOSURE OF THE INVENTION

### Problems to be Solved by the Invention

However, methods of the related art fail to provide a configuration for not displaying an advertisement in accordance with content displayed on each video display device and viewing-related information such as a user's state of viewing the content.

Accordingly, the prevent invention has been made in view of the aforementioned issue of the related art, and it is an object of the present invention to provide an advertisement delivery device, an advertisement delivery system, an advertisement delivery method, an advertisement delivery program, a content display device, a content display program, an information processing terminal, and an information processing program capable of controlling delivery of an advertisement in accordance with content or information regarding the user's viewing of the content.

### Means for Solving the Problems

An aspect of the present invention is an advertisement delivery device including a first obtaining unit that obtains viewing-related information indicating a content viewing state on a content display device: a permission/denial information obtaining unit that obtains permission/denial information associating an advertisement delivery condition with information regarding content; and a delivery control unit that cancels, on the basis of the permission/denial information and the viewing-related information, delivery of a delivery candidate advertisement if the content is being viewed on the content display device.

### Effects of the Invention

According to the aspect of the present invention, an advertisement delivery device, an advertisement delivery system, an advertisement delivery method, an advertisement delivery program, a content display device, a content display program, an information processing terminal, and an information processing program capable of controlling delivery of an advertisement in accordance with content or information regarding the user's viewing of the content.

### BRIEF DESCRIPTION OF THE DRAWINGS

FIG. 1 is a diagram illustrating an example of the configuration of an advertisement delivery system 1 according to a first embodiment.

FIG. 2 is a diagram illustrating an example of a list indicating the cases where an advertisement delivery device 2 delivers an additional advertisement and the cases where the advertisement delivery device 2 does not deliver an additional advertisement.

FIG. 3 is an example of a diagram schematically illustrating the cases where the advertisement delivery device 2 delivers an additional advertisement and the cases where the advertisement delivery device 2 does not deliver an additional advertisement.

FIG. 4 is a diagram illustrating an example of the hardware configuration of the advertisement delivery device 2.

FIG. 5 is a diagram illustrating an example of the functional configuration of the advertisement delivery device 2.

FIG. 6 is a diagram illustrating an example of the functional configuration of a content display device 3.

FIG. 7 is a diagram illustrating an example of the functional configuration of an information processing terminal 4.

FIG. 8 is a flowchart illustrating an example of a process of how a control unit 26 controls delivery of an additional advertisement.

FIG. 9 is a diagram illustrating an example of a list of kinds of additional advertisements delivered through an advertisement delivery process.

FIG. 10 is a flowchart illustrating an example of a process of how a control unit 36 of the content display device 3 displays an additional advertisement upon obtaining the additional advertisement.

FIG. 11 is a sequence diagram illustrating an example of the flow of a process in which the advertisement delivery device 2 delivers an additional advertisement and the content display device 3 displays the delivered additional advertisement.

FIG. 12 is a diagram illustrating an example of how content displayed on the content display device 3 changes from step S310 to step S340 illustrated in FIG. 11.

FIG. 13 is a diagram illustrating a display example of the case where an additional advertisement that is delivered from the advertisement delivery device 2 is displayed on the content display device 3.

FIG. 14 is a diagram illustrating a display example of the case where an additional advertisement that is delivered from the advertisement delivery device 2 is displayed on the information processing terminal 4.

FIG. 15 is a diagram illustrating an example in which a setup window is displayed on the content display device 3 or the information processing terminal 4.

FIG. 16 is a diagram for describing an example of advantageous effects obtained by control of delivery of an additional advertisement performed by the advertisement delivery device 2.

FIG. 17 is a diagram illustrating an example of a list of destinations to which the advertisement delivery device 2 delivers an advertisement when the user looks away from the content display device 3.

FIG. 18 is a diagram illustrating an example of the flow of control in which the advertisement delivery device 2 delivers an advertisement to the content display device 3 and the information processing terminal 4 in accordance with the user's line of sight.

FIG. 19 is a diagram illustrating an example of a list of destinations to which the advertisement delivery device 2 delivers an advertisement when the user is out.

FIG. 20 is a first diagram illustrating an image displayed on the content display device 3 in a captured image and a still image of content that was broadcast when the captured image was captured.

FIG. 21 is a second diagram illustrating an image displayed on the content display device 3 in a captured image and a still image of content that was broadcast when the captured image was captured.

FIG. 22 is a diagram illustrating an example of the configuration of an advertisement delivery system 1D according to a fifth embodiment.

FIG. 23 is a diagram illustrating an example of the data structure of content information.

FIG. 24 is a diagram illustrating an example of the data structure of viewing-related information.

FIG. 25 is a diagram illustrating an example of the data structure of permission/denial information.

FIG. 26 is a sequence diagram illustrating an example of the flow of the overall process performed by the advertisement delivery system 1D.

### MODE FOR CARRYING OUT THE INVENTION

### First Embodiment

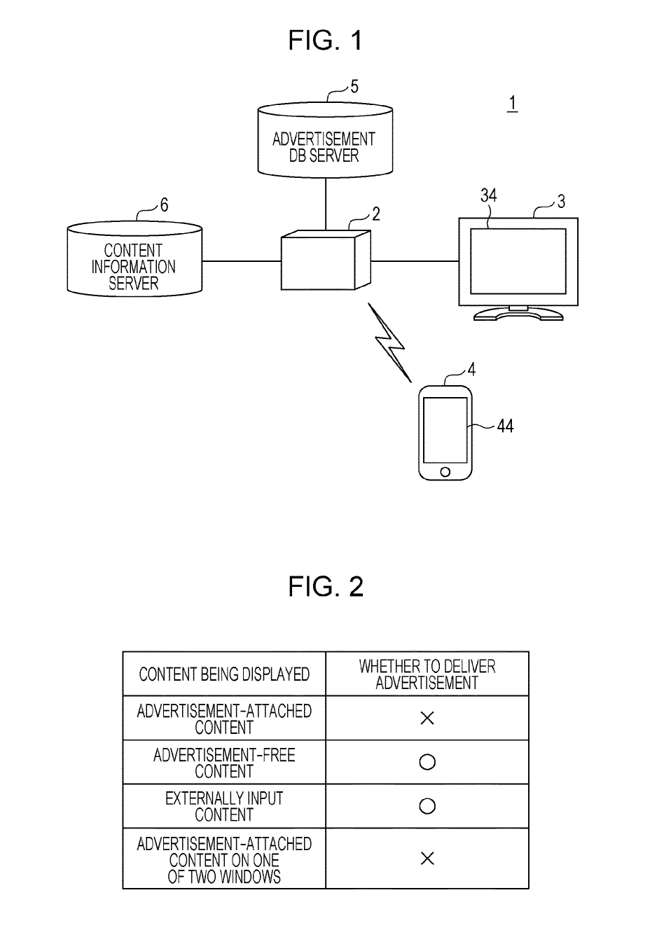

A first embodiment of the present invention will be described below with reference to the drawings. FIG. 1 is a diagram illustrating an example of the configuration of an advertisement delivery system 1 according to the first embodiment. The advertisement delivery system 1 according to the first embodiment includes an advertisement delivery device 2, a content display device 3, an information processing terminal 4 that functions as a second screen of the content display device 3, an advertisement DB server 5, and a content information server 6. The advertisement delivery system 1 may include a plurality of content display devices 3. The advertisement delivery system 1 may include a plurality of information processing terminals 4 or may include no information processing terminal 4.

The advertisement delivery system 1 delivers an advertisement to one or both of the content display device 3 and the information processing terminal 4 to display the advertisement thereon. At that time, the advertisement delivery system 1 controls, in accordance with viewing-related information displayed on the content display device 3, delivery of the advertisement to one or both of the content display device 3 and the information processing terminal 4 that functions as a second screen of the content display device 3. Controlling delivery indicates determining whether to deliver the advertisement in accordance with the viewing-related information and performing delivery of the advertisement in accordance with the determined result; however, it may indicate performing some kind of processing in accordance with the viewing-related information and performing advertisement delivery based on the processing.

The viewing-related information is information indicating the content viewing state on the content display device 3. The viewing-related information is, for example, information including at least one of information for identifying content displayed on the content display device 3 and the information processing terminal 4 (information for identifying content displayed on the content display device 3 if there is no information processing terminal 4), information indicating that the content display device 3 is powered on or off, information indicating the user's line of sight with respect to a display unit of the content display device 3 or a display unit of the information processing terminal 4, and information indicating whether the user is out.

Information for identifying content includes, for example, the content ID for identifying the content and information indicating whether the content is content displayed via an external input terminal, such as an HDMI (registered trademark) terminal. If the content is a broadcast program, information for identifying the content may be constituted by the viewing-related time and the broadcast ID (ID for identifying the broadcasting station) alone. In this case, a table in which content information described later, time, and the broadcast ID are associated with one another is stored in the content information server 6 or the like, and the content displayed on the content display device 3 (i.e., viewed by the user) is identified with reference to the table in the advertisement delivery system 1. In addition, if the content is a recorded broadcast program, a table in which the recording date/time of the content and the broadcasting station ID are associated with the content information is stored and the content displayed on the content display device 3 is identified on the basis of the table in the advertisement delivery system 1. It is assumed that information indicating the user's line of sight with respect to the display unit of the content display device 3 or the display unit of the information processing terminal 4 is included in the viewing-related information if the content display device 3 or the information processing terminal 4 includes an image capturing unit that detects the user's line of sight.

Information indicating whether the user is out is information detected as a result of the content display device 3 or the information processing terminal 4 determining whether the user is out depending on whether an access point to which the information processing terminal 4 is connected to perform communication is connected to an access point registered in advance in the advertisement delivery system 1 in the case where the user is using the information processing terminal 4. In the case where the content display device 3 performs the above determination, the content display device 3 obtains, from the information processing terminal 4, information indicating the access point to which the information processing terminal 4 is connected and then performs the above determination. In the case where the information processing terminal 4 performs the above determination, the information processing terminal 4 transmits the determined result to the content display device 3.

Note that content described in this embodiment indicates, for example, a television program and a radio program that are broadcast; VOD (Video On Demand) content that is viewable via the Internet or the like; and a moving image (recorded moving image or video work such as a movie, a TV drama, or a music video) that is played by a DVD (registered trademark) player, a BD (Blu-ray Disc, registered trademark) player, or the like and that is viewable via an external input terminal, such as an HDMI (High-Definition Multimedia Interface, registered trademark) terminal. The following description will be given by referring to a broadcast television or radio program as broadcast content and by referring to a moving image that is viewable via an external input terminal as externally input content, for convenience of explanation.

For content sponsored by a sponsor, an advertisement of the sponsor is sometimes displayed to promote sales of the sponsor or to increase name recognition of the sponsor. The following description will be given by referring to content for which an advertisement of a sponsor is displayed as advertisement-attached content and by referring to content for which no advertisement of any sponsor is displayed as advertisement-free content, for convenience of explanation. The externally input content is an example of advertisement-free content. In addition, the following description will be given by referring to an advertisement that is displayed for the advertisement-attached sponsor as an original advertisement.

In the case where the advertisement delivery system 1 delivers an advertisement to the information processing terminal 4 via the content display device 3, the advertisement delivery system 1 delivers the advertisement to the content display device 3 in accordance with the aforementioned viewing-related information. Then, in accordance with a user setting indicating whether to display the advertisement on one or both of the main screen (i.e., the display unit of the content display device 3) and the second screen (i.e., the display unit of the information processing terminal 4), the content display device 3 causes the advertisement delivered from the content display device 3 to be displayed on the screen(s) (one or both of the main screen and the second screen) indicated by the setting.

In the case where the advertisement delivery system 1 delivers the advertisement to the information processing terminal 4 not via the content display device 3, the advertisement delivery system 1 obtains in advance, from the content display device 3 or the information processing terminal 4, setting information that associates information (e.g., ID or the like) indicating the content display device 3 from the content display device 3, information (e.g., ID or the like) indicating the information processing terminal 4, and information indicating the screen(s) used for display (one or both of the main screen and the second screen) with one another. The advertisement delivery system 1 controls delivery of the advertisement on the basis of the viewing-related information and the setting information.

The case where the advertisement delivery system 1 delivers an advertisement to the information processing terminal 4 via the content display device 3 will be described below for convenience of explanation. Advertisement delivery control performed by the advertisement delivery system 1, which will be described below, is also applicable to the case where the advertisement delivery system 1 delivers the advertisement to the information processing terminal 4 not via the content display device 3 instead of the above case.

The advertisement delivery device 2 obtains various kinds of advertisements from the advertisement DB server 5. It is assumed below that these advertisements are advertisements of sponsors different from the sponsor of the aforementioned original advertisement, and the description will be given below by referring to these advertisements as additional advertisements for convenience of explanation. Note that an additional advertisement may be the same as the original advertisement. The advertisement delivery device 2 obtains, as the viewing-related information, information relating to viewing of content displayed on the content display device 3 and the information processing terminal 4 from the content display device 3. An additional advertisement is an example of an advertisement.

The advertisement delivery device 2 further obtains, as advertisement presence/absence information, information indicating whether the content displayed on the content display device 3 and the information processing terminal 4 is advertisement-attached content or advertisement-free content from the content display device 3. If the viewing-related information indicates that the content displayed on the content display device 3 and the information processing terminal 4 is associated with a broadcast ID indicating the broadcasting station that broadcasts the content, the advertisement delivery device 2 identifies the content from the content information server 6 on the basis of the broadcast ID of the content and the current time, and obtains content information relating to the identified content from the content information server 6. The following description will be given by referring to the advertisement delivery device 2 obtaining content information on the basis of the broadcast ID and the current time as the advertisement delivery device 2 obtaining content information on the basis of the broadcast ID, for convenience of explanation. Note that content information is information that describes details of the content and is, for example, information associating the content ID for identifying the content, the broadcast ID, and information regarding incident(s) that happen in the content (hereinafter, referred to as “event(s)”) with one another.

An event indicates every single incident such as the cast making a statement or video being replayed. Information regarding events is, for example, information containing, for each of the events, the time (hereinafter, referred to as event start time) at which the event happens, the time (hereinafter, referred to as event end time) at which the event ends, detailed event information, the name of the session (hereinafter, referred to as an event-containing session) during which the event happens, the broadcast ID associated with the content in which the event happens, and so on. Detailed event information is, for example, text information that records the name of a store and the name of a product introduced during the event, and details of the statement of the cast, the names of the cast, the actions of the cast, and facial expressions of the cast who are on the screen during the event.

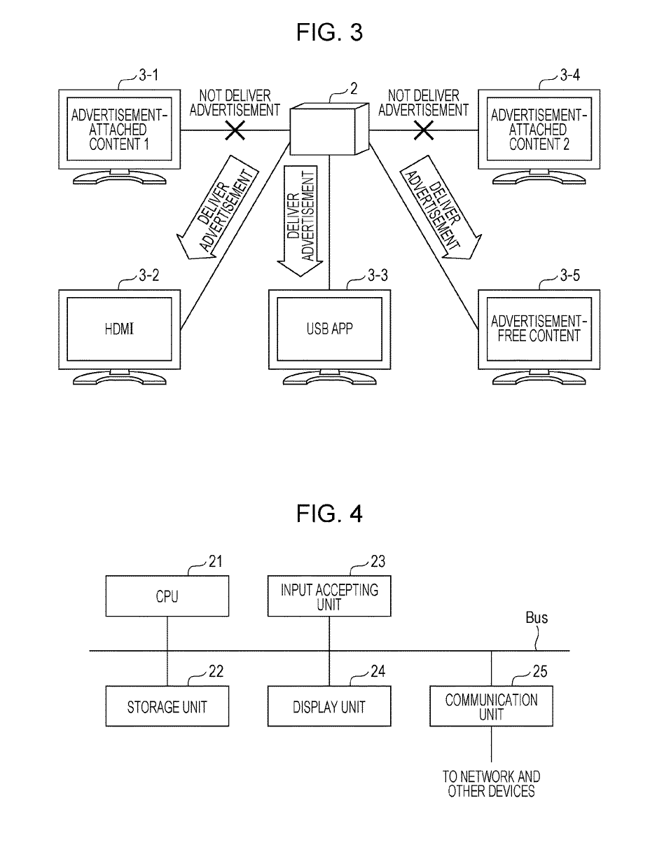

The advertisement delivery device 2 controls delivery of the obtained additional advertisement to the content display device 3 on the basis of the viewing-related information, the advertisement presence/absence information, and the content information that have been obtained. Now, how the advertisement delivery device 2 controls delivery of an additional advertisement is described with reference to FIGS. 2 and 3. FIG. 2 is a diagram illustrating an example of a list indicating the cases where the advertisement delivery device 2 delivers an additional advertisement and the cases where the advertisement delivery device 2 does not deliver an additional advertisement. FIG. 3 is an example of a diagram schematically illustrating the cases where the advertisement delivery device 2 delivers an additional advertisement and the cases where the advertisement delivery device 2 does not deliver an additional advertisement.

If advertisement-attached content is displayed on the content display device 3, the original advertisement of the sponsor different from the sponsor of the additional advertisement delivered from the advertisement delivery device 2 is displayed for the content. If the advertisement delivery device 2 delivers the additional advertisement, the expected effect (e.g., sales promotion effect) of the original advertisement on the viewer is possibly decreased. Accordingly, if advertisement-attached content is displayed on one of the content display device 3 and the information processing terminal 4, the advertisement delivery device 2 delivers the additional advertisement to neither the content display device 3 nor the information processing terminal 4 as illustrated in FIG. 2 (indicated by “x” in FIG. 2).

If advertisement-free content is displayed on both of the content display device 3 and the information processing terminal 4, the advertisement delivery device 2 delivers an additional advertisement to the content display device 3 (indicated by “◯” in FIG. 2). As described above, the delivered additional advertisement is displayed on the display unit of the information processing terminal 4 as a result of the content display device 3 outputting the delivered additional advertisement to the information processing terminal 4 if a setting for displaying the additional advertisement on the second screen is set in the content display device 3 in this embodiment. If externally input content is displayed on one of the content display device 3 and the information processing terminal 4 and advertisement-attached content is displayed on neither the content display device 3 nor the information processing terminal 4, no original advertisement is displayed. Thus, the advertisement delivery device 2 delivers the additional advertisement to the content display device 3.

The content display device 3 is a display device for displaying (reproducing) content and is, for example, a device, such as a television receiver, capable of displaying broadcast content or externally input content that is input via an external input terminal, such as an HDMI terminal. The content display device 3 outputs viewing-related information regarding content displayed thereon and advertisement presence/absence information regarding the content to the advertisement delivery device 2. The description will be given below on the assumption that the content display device 3 outputs the viewing-related information and the advertisement presence/absence information to the advertisement delivery device 2 every time a predetermined period (e.g., several seconds) passes. Instead of this configuration, the content display device 3 may output the viewing-related information and the advertisement presence/absence information to the advertisement delivery device 2 in response to a request from the advertisement delivery device 2.

The content display device 3 obtains the additional advertisement delivered from the advertisement delivery device 2 and displays the obtained additional advertisement. If a setting for causing the information processing terminal 4 to function as a second screen is set (such as if information indicating the information processing terminal 4 is registered in the content display device 3 as information indicating the second screen) and a setting for displaying the additional advertisement on the second screen is also set, the content display device 3 outputs to and displays on the information processing terminal 4 the additional advertisement delivered from the advertisement delivery device 2.

The information processing terminal 4 is a terminal that functions as the second screen of the content display device 3 in accordance with a dedicated application or the like and is, for example, a display of various kinds such as an organic EL (Electro Luminescence) display, a tablet PC (Personal Computer), a notebook PC, a desktop PC, a mobile phone terminal, a multi-functional mobile phone terminal (smartphone), an electronic book reader, a PDA (Personal Digital Assistant), or a display-equipped home electrical product of other kinds (such as a smart home electrical product). The dedicated application that enables the additional advertisement delivered from the advertisement delivery device 2 to be displayed is installed on the information processing terminal 4. It is assumed that the ID for identifying the content display device 3 is registered in advance in the information processing terminal 4 so that the information processing terminal 4 functions as the second screen of the content display device 3.

The advertisement DB server 5 is a server that stores additional advertisements. The advertisement DB server 5 stores additional advertisements for the purpose of promoting sales and increasing name recognition of various entities and outputs various additional advertisements in response to a request from the advertisement delivery device 2.

The content information server 6 is a server that stores content information. The content information server 6 outputs various kinds of content information in response to a request from the advertisement delivery device 2.

The hardware configuration of the advertisement delivery device 2 will be described below with reference to FIG. 4. FIG. 4 is a diagram illustrating an example of the hardware configuration of the advertisement delivery device 2. The advertisement delivery device 2 includes, for example, a CPU (Central Processing Unit) 21, a storage unit 22, an input accepting unit 23, a display unit 24, and a communication unit 25. The advertisement delivery device 2 communicates via the communication unit 25 with various servers and various devices connected to a network. These components are connected to one another via a bus Bus to be able to communicate with one another. The CPU 21 executes various programs stored in the storage unit 22.

The storage unit 22 includes, for example, an HDD (Hard Disk Drive) or an SSD (Solid State Drive), an EEPROM (Electrically Erasable Programmable Read-Only Memory), a ROM (Read-Only Memory), and a RAM (Random Access Memory). The storage unit 22 stores various kinds of information, images, and programs processed by the advertisement delivery device 2. Note that the storage unit 22 may be an external storage device that is connected via a digital input/output port such as USB, instead of the one built in the advertisement delivery device 2.

The input accepting unit 23 is, for example, a keyboard and mouse, a touchpad, or an input device of other types. Note that the input accepting unit 23 may include a touch panel together with the display unit 24.

The display unit 24 is, for example, a liquid crystal display panel or an organic EL display panel.

The communication unit 25 includes, for example, a digital input/output port such as USB and an Ethernet (registered trademark) port.

The content display device 3 and the information processing terminal 4 have the hardware configuration substantially the same as the hardware configuration illustrated in FIG. 4. In order to distinguish the hardware configuration of the content display device 3 from the hardware configuration of the advertisement delivery device 2, the components of the content display device 3 are referred to as a CPU 31, a storage unit 32, an input accepting unit 33, a display unit 34, and a communication unit 35 below. In addition, in order to distinguish the hardware configuration of the information processing terminal 4 from the hardware configuration of the advertisement delivery device 2, the components of the information processing terminal 4 are referred to as a CPU 41, a storage unit 42, an input accepting unit 43, a display unit 44, and a communication unit 45.

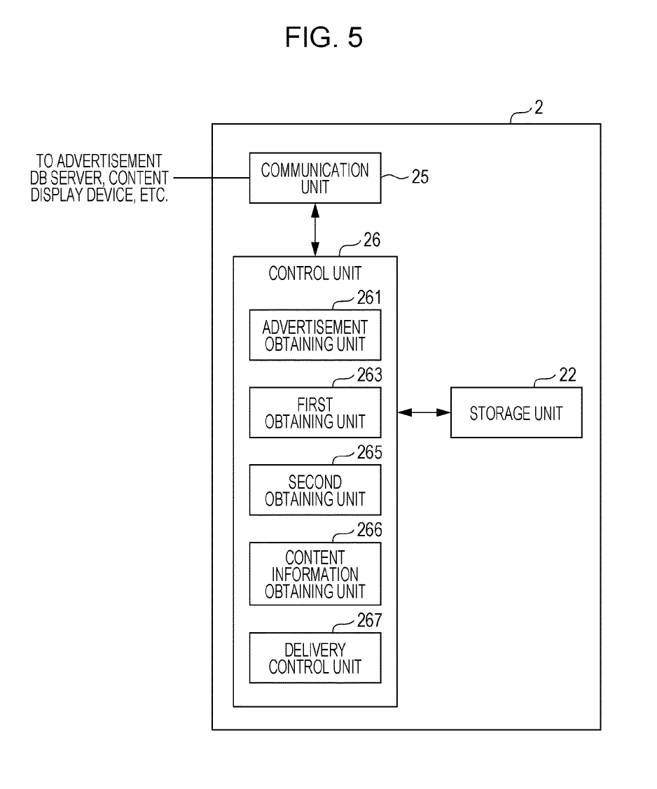

The functional configuration of the advertisement delivery device 2 will be described below with reference to FIG. 5. FIG. 5 is a diagram illustrating an example of the functional configuration of the advertisement delivery device 2. The advertisement delivery device 2 includes the storage unit 22, the communication unit 25, and a control unit 26. The control unit 26 includes an advertisement obtaining unit 261, a first obtaining unit 263, a second obtaining unit 265, a content information obtaining unit 266, and a delivery control unit 267. Some of or all of these functional units of the control unit 26 are implemented as a result of the CPU 21 executing various programs stored in the storage unit 22, for example. In addition, some of or all of the functional units of the control unit 26 may be a hardware-implemented functional unit, such as an LSI (Large Scale Integration) or an ASIC (Application Specific Integrated Circuit).

The advertisement obtaining unit 261 obtains an additional advertisement from the advertisement DB server 5.

The first obtaining unit 263 obtains the viewing-related information from the content display device 3. The first obtaining unit 263 obtains the viewing-related information transmitted from the content display device 3 at predetermined intervals. Instead of this configuration, the first obtaining unit 263 may transmit a viewing-related-information obtain request to the content display device 3 at predetermined intervals and may obtain the viewing-related information as a response to the request. In addition, the first obtaining unit 263 may obtain the viewing-related information transmitted from the content display device 3 at predetermined timings. The predetermined timings are, for example, any given combination of timings A1 to A5 below when content is displayed on only one of the content display device 3 and the information processing terminal 4.

A1) Timing at which the content is switched from advertisement-attached content to advertisement-free content
A2) Timing at which the content is switched from advertisement-attached content to externally input content
A3) Timing at which a predetermined period (e.g., several seconds) has passed when the content is advertisement-free content or externally input content
A4) Timing immediately after the content display device 3 is powered on when the content is advertisement-free content or externally input content
A5) Timing at which the user again looks at the display unit 34 that displays the content after looking away from the display unit 34 when the content is advertisement-free content or externally input content

In addition, the predetermined timings are, for example, any given combination of timings B1 to B5 below when content is displayed on each of the content display device 3 and the information processing terminal 4 and the information processing terminal 4 is functioning as the second screen.

B1) Timing at which advertisement-attached content disappears from the content displayed on both of the content display device 3 and the information processing terminal 4
B2) Timing at which the predetermined period has passed when the content displayed on each of the content display device 3 and the information processing terminal 4 is advertisement-free content or externally input content
B3) Tuning immediately after one of the content display device 3 and the information processing terminal 4 is powered on when the content displayed thereon is advertisement-free content or externally input content
B4) Timing at which the user again looks at the display unit 34 or the display unit 44 that displays content after looking away from the display unit 34 or the display unit 44 when the content displayed on each of the content display device 3 and the information processing terminal 4 is advertisement-free content or externally input content
B5) Timing immediately after the content display device 3 is powered off when content displayed on each of the content display device 3 and the information processing terminal 4 is advertisement-free content or externally input content

In addition, the predetermined timings are, for example, any given combination of timings C1 to C5 below when content is displayed on one of the content display device 3 and the information processing terminal 4 and the information processing terminal 4 is functioning as the second screen.

C1) Timing at which advertisement-attached content disappears from the content
C2) Timing at which the predetermined period has passed when the content is advertisement-free content or externally input content
C3) Timing immediately after one of the content display device 3 and the information processing terminal 4 is powered on when the content is advertisement-free content or externally input content
C4) Timing at which the user again looks at the display unit 34 or the display unit 44 that displays the content after looking away from the display unit 34 or the display unit 44 when the content is advertisement-free content or externally input content
C5) Timing immediately after the content display device 3 is powered off when the content is advertisement-free content or externally input content

The second obtaining unit 265 obtains the advertisement presence/absence information from the content display device 3. The first obtaining unit 263 obtains the advertisement presence/absence information transmitted from the content display device 3 at predetermined intervals. Instead of this configuration, the first obtaining unit 263 may transmit an advertisement-presence/absence-information obtain request to the content display device 3 at predetermined intervals and may obtain the advertisement presence/absence information as a response to the request. In addition, the second obtaining unit 265 may obtain the advertisement presence/absence information transmitted from the content display device 3 at the predetermined timings.

In addition, one of the first obtaining unit 263 and the second obtaining unit 265 may be integrated into the other functional unit out of the first obtaining unit 263 and the second obtaining unit 265. In such a case, it is assumed that one of the viewing-related information and the advertisement presence/absence information is included in the other one.

The content information obtaining unit 266 obtains content information from the content information server 6.

The delivery control unit 267 determines whether to deliver the additional advertisement obtained by the advertisement obtaining unit 261 to the content display device 3 on the basis of the viewing-related information obtained by the first obtaining unit 263, the advertisement presence/absence information obtained by the second obtaining unit 265, and the content information obtained by the content information obtaining unit 266. The delivery control unit 267 delivers the additional advertisement to the content display device 3 via the communication unit 25 if it determines to deliver the additional advertisement through the above determination. The delivery control unit 267 does not deliver the additional advertisement to the content display device 3 via the communication unit 25 if it determines not to deliver the additional advertisement through the above determination.

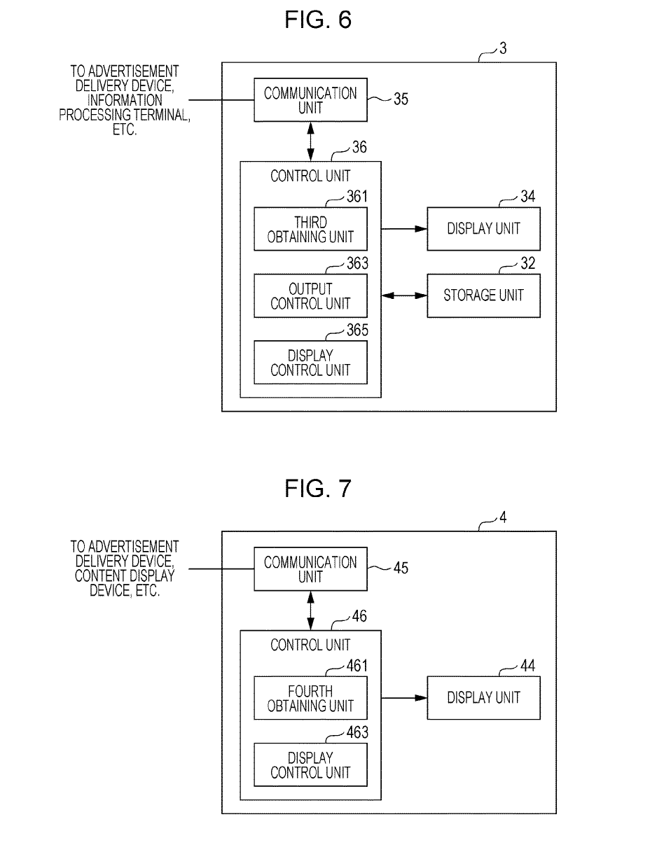

The functional configuration of the content display device 3 will be described below with reference to FIG. 6. FIG. 6 is a diagram illustrating an example of the functional configuration of the content display device 3. The content display device 3 includes the storage unit 32, the display unit 34, the communication unit 35, and a control unit 36. The control unit 36 includes a third obtaining unit 361, an output control unit 363, and a display control unit 365.

The third obtaining unit 361 obtains the additional advertisement from the advertisement delivery device 2 via the communication unit 35.

The output control unit 363 outputs the viewing-related information of the content display device 3 to the advertisement delivery device 2 via the communication unit 35. In addition, the output control unit 363 outputs the viewing-related information regarding content displayed on the content display device 3 and the information processing terminal 4 to the advertisement delivery device 2 via the communication unit 35 if the information processing terminal 4 is functioning as the second screen. The output control unit 363 outputs the viewing-related information to the advertisement delivery device 2 at predetermined intervals. Instead of this configuration, the output control unit 363 may output the viewing-related information in accordance with the viewing state on the content display device 3, when a power-on process is completed, and when a power-off process is started or may output the viewing-related information in response to a request from the advertisement delivery device 2.

The output control unit 363 also outputs the advertisement presence/absence information regarding content displayed on the content display device 3 to the advertisement delivery device 2 via the communication unit 35. The output control unit 363 also outputs the advertisement presence/absence information regarding content displayed on the content display device 3 and the information processing terminal 4 to the advertisement delivery device 2 via the communication unit 35 if the information processing terminal 4 is functioning as the second screen. The output control unit 363 outputs the advertisement presence/absence information to the advertisement delivery device 2 at predetermined intervals. Instead of this configuration, the output control unit 363 may output the advertisement presence/absence information in accordance with the viewing state on the content display device 3, when a power-on process is completed, and when a power-off process is started or may output the advertisement presence/absence information in response to a request from the advertisement delivery device 2. In addition, the output control unit 363 outputs to and displays on the information processing terminal 4 the additional advertisement obtained from the advertisement delivery device 2 if the information processing terminal 4 is functioning as the second screen of the content display device 3 and a user setting is set so that the additional advertisement is displayed on the information processing terminal 4.

The display control unit 365 causes the additional advertisement obtained by the third obtaining unit 361 to be displayed on the display unit 34 if the information processing terminal 4 is not functioning as the second screen. In addition, the display control unit 365 causes the additional advertisement obtained by the third obtaining unit 361 to be displayed on the display unit 34 if the information processing terminal 4 is functioning as the second screen but a user setting is set so that the additional advertisement is displayed on the main screen (i.e., the content display device 3).

The functional configuration of the information processing terminal 4 will be described below with reference to FIG. 7. FIG. 7 is a diagram illustrating an example of the functional configuration of the information processing terminal 4. The information processing terminal 4 includes the display unit 44, the communication unit 45, and a control unit 46. The control unit 46 includes a fourth obtaining unit 461 and a display control unit 463.

The fourth obtaining unit 461 obtains the additional advertisement from the content display device 3.

The display control unit 463 causes the additional advertisement obtained by the fourth obtaining unit 461 to be displayed on the display unit 44 if the information processing terminal 4 is functioning as the second screen of the content display device 3 and a user setting is set so that the additional advertisement is displayed on the second screen.

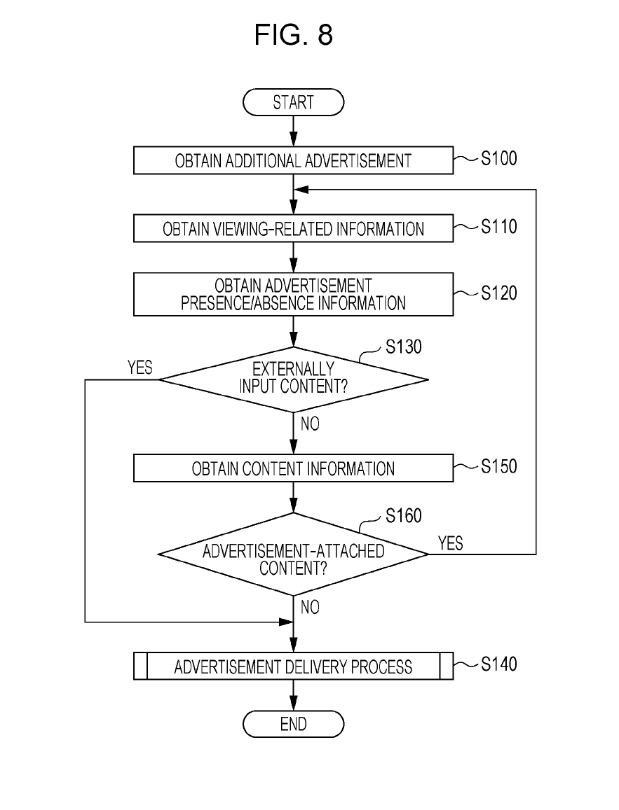

A process of how the control unit 26 controls delivery of an additional advertisement will be described below with reference to FIG. 8. FIG. 8 is a flowchart illustrating an example of the process of how the control unit 26 controls delivery of an additional advertisement. The case where content is displayed on the content display device 3 and no content is displayed on the information processing terminal 4 will be described below by way of example. First, the advertisement obtaining unit 261 obtains an additional advertisement from the advertisement DB server 5 step S100). Then, the first obtaining unit 263 obtains viewing-related information from the content display device 3 (step S110). Then, the second obtaining unit 265 obtains advertisement presence/absence information from the content display device 3 (step S120).

Then, the delivery control unit 267 determines whether the content displayed on the content display device 3 is externally input content on the basis of the viewing-related information obtained in step S110 (step S130). If the delivery control unit 267 determines that the content is not externally input content (step S130—No), the content information obtaining unit 266 extracts content displayed on the content display device 3 and the information processing terminal 4 from the viewing-related information obtained in step S110 and obtains content information regarding the extracted content from the content information server 6 (step S150). Then, the delivery control unit 267 determines whether the content displayed on the content display device 3 is advertisement-attached content on the basis of the advertisement presence/absence information obtained in step S120 and the content information obtained in step S160 (step S160).

Now, a process of how the delivery control unit 267 determines whether displayed content is advertisement-attached content is described. If the content displayed on the content display device 3 is not externally input content, the delivery control unit 267 extracts information for identifying the content displayed on the content display device 3 and the broadcast ID for broadcasting the content with reference to the content information obtained in step S160.

Then, the delivery control unit 267 determines whether the content is advertisement-attached content on the basis of the extracted information for identifying the content and the extracted broadcast ID. For example, the delivery control unit 267 performs this determination on the basis of information indicating advertisement-attached content stored in advance in the storage unit 32. Information indicating advertisement-attached content includes, for example, broadcast IDs for identifying broadcasting stations for which no original advertisement is displayed and information for identifying content for which no original advertisement is displayed.

If the delivery control unit 267 determines that the displayed content is advertisement-attached content through this determination, the delivery control unit 267 skips the determination performed using the advertisement presence/absence information obtained in step S120, for example. In addition, if the delivery control unit 267 determines that the displayed content is not advertisement-attached content through this determination, the delivery control unit 267 determines whether the content displayed on the content display device 3 is advertisement-attached content on the basis of the advertisement presence/absence information obtained in step S120. Note that the processing of step S160 may be omitted and the delivery control unit 267 may skip the determination of as to whether the displayed content is advertisement-attached content based on the content information. Alternatively, the processing of step S120 may be omitted and the delivery control unit 267 may skip the determination of as to whether the displayed content is advertisement-attached content based on the advertisement presence/absence information.

If it is determined in step S170 that the content displayed on the content display device 3 is advertisement-attached content (step S170—Yes), the delivery control unit 267 determines that no additional advertisement is to be delivered. The process then returns to step S110, in which the delivery control unit 267 obtains the next viewing-related information. On the other hand, if it is determined that the content displayed on the content display device 3 is not advertisement-attached content (step S170—No), the delivery control unit 267 determines that an additional advertisement is to be delivered and delivers the additional advertisement to the content display device 3 (step S140).

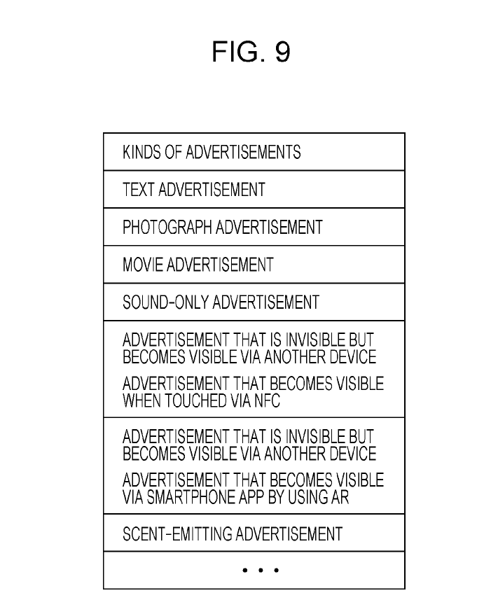

Now, kinds of additional advertisements delivered through the advertisement delivery process are described with reference to FIG. 9. FIG. 9 is a diagram illustrating an example of a list of kinds of additional advertisements delivered through the advertisement delivery process. As illustrated in FIG. 9, additional advertisements include advertisements, such as text advertisement composed only of text (such as character strings and symbols), photograph advertisement composed of photograph data, movie advertisement composed of moving images, sound-only advertisement composed of audio data, advertisement that is invisible but becomes visible via another device (e.g., advertisement that becomes visible via a multi-functional mobile phone terminal or the like by using augmented reality), and scent-emitting advertisement that emits specific scent by using a scent generator.

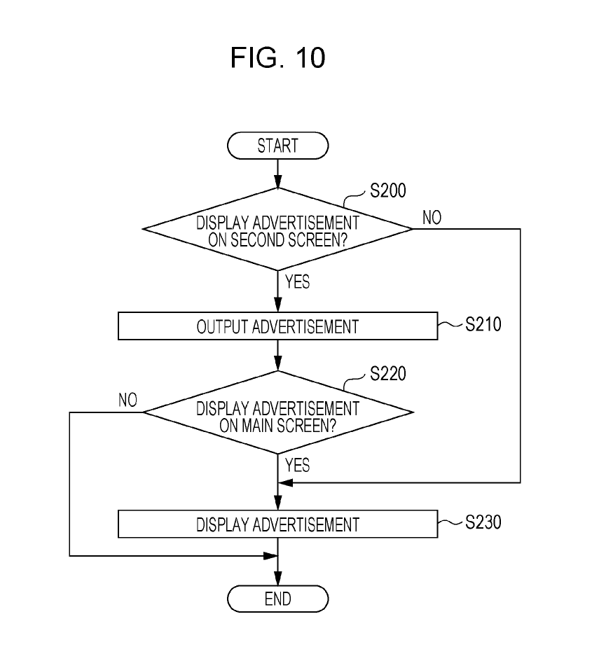

A process of how the control unit 36 of the content display device 3 displays an additional advertisement upon obtaining the additional advertisement will be described below with reference to FIG. 10. FIG. 10 is a flowchart illustrating an example of the process of how the control unit 36 of the content display device 3 displays an additional advertisement upon obtaining the additional advertisement. The process that is performed after the third obtaining unit 361 of the control unit 36 obtains the additional advertisement from the advertisement delivery device 2 will be described below. First, the output control unit 363 determines whether a setting is set by the user in the content display device 3 so that the information processing terminal 4 functions as the second screen and that an additional advertisement is to be displayed on the second screen (step S200).

If it is determined that the setting is set by the user in the content display device 3 so that the information processing terminal 4 functions as the second screen and an additional advertisement is to be displayed on the second screen (step S200—Yes), the output control unit 363 outputs the additional advertisement obtained from the advertisement delivery device 2 to the information processing terminal 4 to cause the additional advertisement to be displayed on the information processing terminal 4 (step S210). Then, the display control unit 365 determines whether a setting is set by the user in the content display device 3 so that the additional advertisement is to be displayed on the display unit 34 of the content display device 3 (step S220).

If it is determined that the setting is set by the user in the content display device 3 so that the additional advertisement is to be displayed on the display unit 34 of the content display device 3 (step S220—Yes), the display control unit 365 displays the additional advertisement obtained from the advertisement delivery device 2 on the display unit 34 (step S230). On the other hand, if it is determined that the setting for displaying the additional advertisement on the display unit 34 of the content display device 3 is not set by the user (step S220—No), the display control unit 365 ends the process.

If the output control unit 363 determines in step S200 that the setting for causing the information processing terminal 4 to function as the second screen and for displaying an additional advertisement on the second screen is not set by the user in the content display device 3 (step S200—No), the process proceeds to step S230, in which the display control unit 365 causes the additional advertisement obtained from the advertisement delivery device 2 to be displayed on the display unit 34.

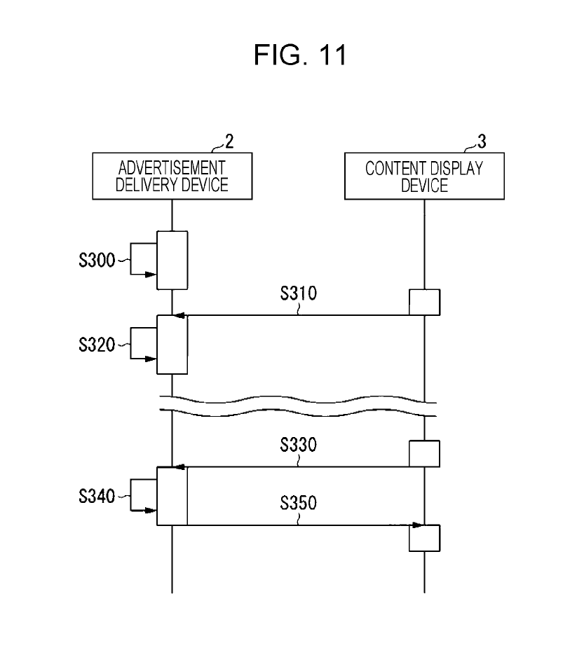

The flow of a process in which the advertisement delivery device 2 delivers an additional advertisement and the content display device 3 displays the delivered additional advertisement will be described below with reference to FIG. 11. FIG. 11 is a sequence diagram illustrating an example of the flow of the process in which the advertisement delivery device 2 delivers an additional advertisement and the content display device 3 displays the delivered additional advertisement. First, the advertisement delivery device 2 obtains an additional advertisement from the advertisement DB server 5 (step S300). Then, the content display device 3 outputs, to the advertisement delivery device 2, viewing-related information regarding content displayed thereon and advertisement presence/absence information regarding the content (step S300).

Then, the advertisement delivery device 2 obtains the viewing-related information and the advertisement presence/absence information from the content display device 3. Then, the advertisement delivery device 2 extracts content displayed on the content display device 3 on the basis of the obtained viewing-related information, and obtains content information regarding the extracted content from the content information server 6. Then, the advertisement delivery device 2 determines whether to deliver the additional advertisement to the content display device 3 on the basis of the viewing-related information, the advertisement presence/absence information, and the content information (step S320). The following description will be given on the assumption that the advertisement delivery device 2 determines in the determination of step S320 that the additional advertisement is not to be delivered to the content display device 3 (for example, advertisement-attached content is displayed on the content display device 3).

After some time has passed from step S320, the content display device 3 outputs, to the advertisement delivery device 2, viewing-related information regarding content displayed thereon and advertisement presence/absence information regarding the content (step S330). Then, the advertisement delivery device 2 extracts the content displayed on the content display device 3 on the basis of the obtained viewing-related information and obtains content information regarding the extracted content from the content information server 6. Then, the advertisement delivery device 2 determines whether to deliver the additional advertisement to the content display device 3 on the basis of the viewing-related information, the advertisement presence/absence information, and the content information (step S340). The following description will be given on the assumption that the advertisement delivery device 2 determines in determination of step S340 that the additional advertisement is to be delivered to the content display device 3 (for example, externally input content is displayed on the content display device 3).

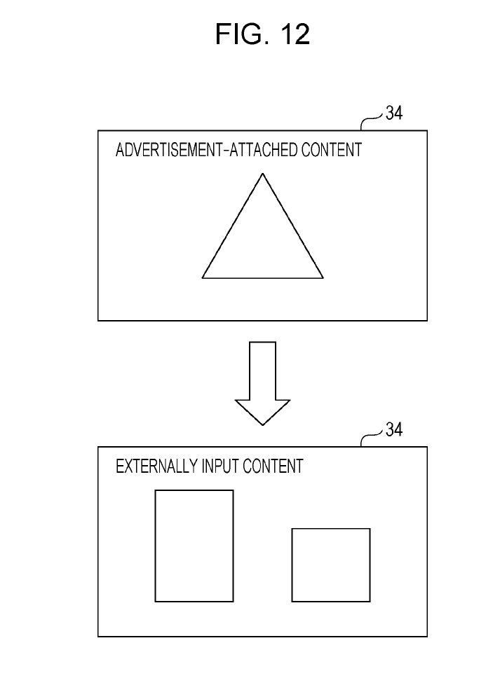

Now, how the content displayed on the content display device 3 changes from step S310 to step S340 illustrated in FIG. 11 is described with reference to FIG. 12. FIG. 12 is a diagram illustrating an example of how the content displayed on the content display device 3 changes from step S310 to step S340 illustrated in FIG. 11. Advertisement-attached content is displayed on the display unit 34 of the content display device 3 at the time point of step S310 illustrated in FIG. 11 as illustrated in FIG. 12. In a period after the processing of step S320 is performed and before the processing of step S330 is performed in FIG. 11, the content display device 3 changes from the state where the advertisement-attached content is displayed to the state where externally input content is displayed as illustrated in FIG. 12. Since this change is reflected in the viewing-related information, the advertisement delivery device 2 determines in step S340 illustrated in FIG. 11 that the additional advertisement is to be delivered.

After determining in step S340 that the additional advertisement is to be delivered to the content display device 3, the advertisement delivery device 2 delivers the additional advertisement obtained in step S300 to the content display device 3 (step S350). Note that if the information processing terminal 4 functions as the second screen of the content display device 3, the content display device 3 performs the process of the flowchart illustrated in FIG. 10 to display the additional advertisement obtained from the advertisement delivery device 2 on one or both of the content display device 3 and the information processing terminal 4.

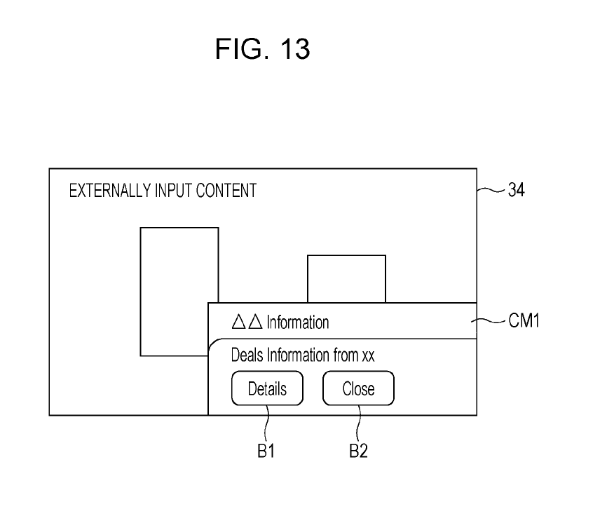

Now, how the additional advertisement delivered from the advertisement delivery device 2 is displayed is described with reference to FIG. 13. FIG. 13 is a diagram illustrating a display example of the case where the additional advertisement delivered from the advertisement delivery device 2 is displayed on the content display device 3 and a display example of the case where the additional advertisement is displayed on the information processing terminal 4. FIG. 13 illustrates a display example of the case where the additional advertisement delivered from the advertisement delivery device 2 is displayed on the content display device 3.

The description will be given of FIG. 13 on the assumption that externally input content is displayed on the display unit 34 of the content display device 3 in addition to the additional advertisement. As illustrated in FIG. 13, the content display device 3 displays an additional advertisement CM1, for example, at a lower right portion of the display unit 34. Note that the content display device 3 may display the additional advertisement at another position of the display device 34, such as an upper right portion, an upper left portion, a lower left portion, an upper end portion, a lower end portion, a right end portion, or a left end portion of the display unit 34. In addition, a text-information-based advertisement is displayed as the additional advertisement CM1 in FIG. 13; however, the displayed advertisement may be an advertisement based on any given combination of various kinds of information that function as an advertisement, such as text information, a moving image, a still image, sound, and scent.

The additional advertisement CM1 includes a detail button B1 and a close button B2. If the user selects the detail button B1, the content display device 3 displays detailed information of the additional advertisement CM1 on the display unit 34. If the user selects the close button B2, the content display device 3 stops displaying the additional advertisement CM1 on the display unit 34. Note that buttons such as the detail button B1 and the close button B2 may be displayed for the additional advertisement CM1 or may be omitted.

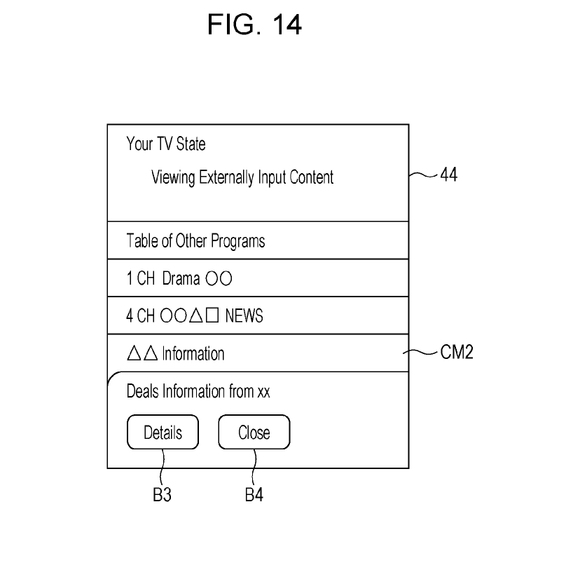

FIG. 14 illustrates a display example of the case where the additional advertisement delivered from the advertisement delivery device 2 is displayed on the information processing terminal 4. The description will be given of FIG. 14 on the assumption that the information processing terminal 4 displays, on the display unit 44, in addition to the additional advertisement, information indicating the content displayed on the content display device 3 and a table of content (illustrated as a table of other programs in FIG. 14) displayable on the content display device.

As illustrated in FIG. 14, the information processing terminal 4 displays an additional advertisement CM2, for example, at a lower end portion of the display unit 44. Note that the information processing terminal 4 may display the additional advertisement at another position of the display unit 44, such as an upper right portion, a lower right portion, an upper left portion, a lower left portion, an upper end portion, a right end portion, or a left end portion of the display unit 44. In addition, a text-information-based advertisement is displayed as the additional advertisement CM2 in FIG. 14; however, the displayed advertisement may be an advertisement based on any given combination of various kinds of information that function as an advertisement, such as text information, a moving image, a still image, sound, and scent.

The additional advertisement CM2 includes a detail button B3 and a close button B4 just like the additional advertisement CM1. If the user selects the detail button B3, the information processing terminal 4 displays detailed information of the additional advertisement CM2 on the display unit 44. If the user selects the close button B4, the information processing terminal 4 stops displaying the additional advertisement CM2 on the display unit 44.

Note that buttons such as the detail button B3 and the close button B4 may be displayed for the additional advertisement CM2 or may be omitted.

In place of the configuration in which one or both of the content display device 3 and the information processing terminal 4 display an additional advertisement on the display unit(s) thereof at the timing at which the additional advertisement is delivered from the advertisement delivery device 2 as illustrated in FIG. 13, one or both of the content display device 3 and the information processing terminal 4 may display the additional advertisement when the user displays a setup window (for example, a setup key is pressed using a remote control).

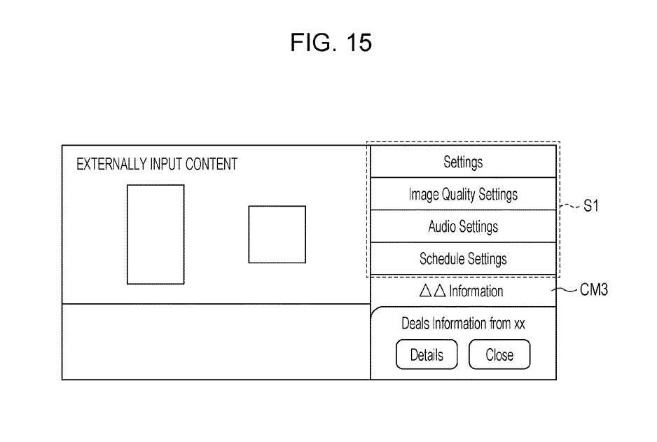

FIG. 15 is a diagram illustrating an example in which a setup window is displayed on the content display device 3 or the information processing terminal 4. The description will be given of FIG. 15 on the assumption that the content display device 3 or the information processing terminal 4 displays externally input content on the display unit in addition to the setup window and the additional advertisement. Referring to FIG. 15, the content display device 3 or the information processing terminal 4 displays a setup window Si at an upper right portion of the display unit and displays an additional advertisement CM3 at a lower right portion. By displaying the additional advertisement CM3 when the user displays the setup window S1, the content display device 3 or the information processing terminal 4 successfully displays the additional advertisement CM3 when desired by the user, and consequently the situation where the additional advertisement CM3 hinders the user from viewing the content is successfully avoided.

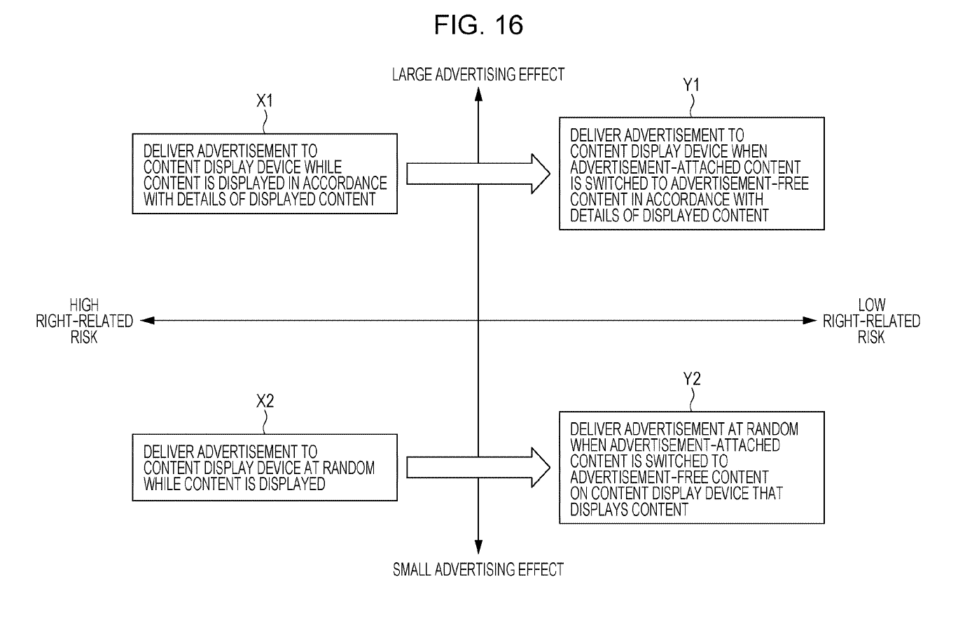

Advantageous effects obtained by control of delivery of an additional advertisement performed by the advertisement delivery device 2 will be described below with reference to FIG. 16. FIG. 16 is a diagram for describing an example of advantageous effects obtained by control of delivery of an additional advertisement performed by the advertisement delivery device 2. Delivery control details X1 and delivery control details X2 illustrated in FIG. 16 are details of how an advertisement delivery device X controls delivery of an additional advertisement (hereinafter, referred to as delivery control details). The advertisement delivery device X is different from the advertisement delivery device 2 and does not control delivery of an additional advertisement on the basis of the viewing-related information. In addition, delivery control details Y1 and delivery control details Y2 illustrated in FIG. 16 describe details of how the advertisement delivery device 2 controls delivery of an additional advertisement.

An additional advertisement gives an additional advertising effect on people who see the advertisement (e.g., viewers of content displayed on the content display device 3). An advertising effect is an effect given by an advertisement. For example, if sales promotion is the purpose of an advertisement, the sales promotion effect corresponds to an advertising effect. Accordingly, an additional advertisement can give an additional advertising effect on people who are viewing content, such as advertisement-free content or externally input content, for which no original advertisement is displayed, if such an additional advertisement is displayed at various delivery timings.

Referring to FIG. 16, positions of the delivery control details X1, X2, Y1, and Y2 in the vertical direction indicate the degree of the advertising effect. The higher the position, the larger the advertising effect given by the additional advertisement delivered in accordance with the delivery control details placed at the position. Conversely, the lower the position, the smaller the advertising effect given by the additional advertisement.

While an additional advertisement can give an additional adverting effect, it may cause a risk that cannot occur when the additional advertisement is not delivered depending on the delivery timing. The risk is as follows. For example, if an additional advertisement is displayed when advertisement-attached content is displayed, the advertising effect which the sponsor that sponsors the advertisement-attached content expects for the original advertisement is decreased in return for the additional advertising effect achieved by the additional advertisement. As a result, a dispute over various rights may occur between the sponsor of the additional advertisement and the sponsor of the original advertisement or a broadcasting station that broadcasts the advertisement-attached content for which the original advertisement of the sponsor is displayed.

It is preferable such a risk be avoided since a claim for damages may be made. In particular, since the broadcasting station that broadcasts the advertisement-attached content creates and broadcasts the content by using money paid by the sponsor of the advertisement-attached content, it is expected that the broadcasting station considers it preferable that an additional advertisement which can be unprofitable for the sponsor of the advertisement-attached content should not be displayed for the advertisement-attached content.

Referring to FIG. 16, positions of the delivery control details X1, X2, Y1, and Y2 in the horizontal direction indicate the degree of the risk (hereinafter, referred to as a right-related risk). As the position becomes closer to the left, the right-related risk that can be caused by the additional advertisement delivered in accordance with the delivery control details placed at the position becomes higher. Conversely, as the position becomes closer to the right, the right-related risk that can be caused by the additional advertisement becomes lower.

The delivery control details X1 indicate that the advertisement delivery device X delivers an additional advertisement to the content display device 3 that displays content in accordance with details of the content displayed on the content display device 3. In the case of such delivery control, the additional advertisement relating to the details of the content is delivered whatever content is displayed on the content display device 3. Accordingly, the advertising effect given by the delivered additional advertisement is high but the right-related risk is also high because the additional advertisement relating to the details of the advertisement-attached content is also delivered.

On the other hand, the delivery control details Y1 indicate that the advertisement delivery device 2 delivers an additional advertisement relating to advertisement-free content to the content display device in accordance with the details of the content displayed on the content display device 3 (that is, on the basis of the viewing-related information, etc.) when advertisement-attached content is switched to the advertisement-free content. In the case of such delivery control, the advertising effect given by the delivered additional advertisement is high because the additional advertisement relating to the advertisement-free content is delivered when the advertisement-free content not accompanied with the original advertisement is displayed. Further, the right-related risk is low because no additional advertisement is delivered when the advertisement-attached content is displayed.

In addition, the delivery control details X2 indicate that the advertisement delivery device X delivers an additional advertisement at random when content is displayed on the content display device 3. In the case of such delivery control, the advertising effect given by the delivered additional advertisement is low because the additional advertisement that may be irrelevant to the details of the content is delivered and the right-related risk is high because the additional advertisement is delivered when advertisement-attached content is displayed.

On the other hand, the delivery control details Y1 indicate that the advertisement delivery device 2 delivers an additional advertisement selected at random to the content display device 3 when advertisement-attached content is switched to advertisement-free content in accordance with the details of the content displayed on the content display device 3 (that is, on the basis of the viewing-related information, etc.). In the case of such delivery control, the advertisement effect given by the delivered additional advertisement is low because the additional advertisement that may be irrelevant to the advertisement-free content is sometimes delivered when the advertisement-free content not accompanied with the original advertisement is displayed but the right-related risk is low because no additional advertisement is delivered when the advertisement-attached content is displayed.

In this way, since the advertisement delivery device 2 delivers no additional advertisement when advertisement-attached content is displayed on one or both of the content display device 3 and the information processing terminal 4 when performing control of delivery of the additional advertisement, the occurrence of the right-related risk is successfully suppressed. Accordingly, the advertisement delivery device 2 successfully gives a large advertising effect on the viewer of the additional advertisement while successfully suppressing the occurrence of a dispute among the sponsor of the original advertisement, the sponsor of the additional advertisement, and the broadcasting station that broadcasts various kinds of content.

As described above, the advertisement delivery system 1 according to the first embodiment obtains, as viewing-related information, information regarding viewing on the content display device 3 and controls delivery of an advertisement on the basis of the obtained viewing-related information. In this way, the advertisement delivery system 1 successfully controls delivery of an additional advertisement in accordance with content and information relating to the user's viewing of the content.

### Second Embodiment

A second embodiment of the present invention will be described below with reference to the drawings. Substantially the same functional units as those according to the first embodiment are denoted by the same reference signs, and a description thereof is omitted. The content display device 3 of the advertisement delivery system 1 according to the second embodiment includes an image capturing unit for detecting the user's line of sight, and viewing-related information includes information indicating the user's line of sight with respect to the display unit 34 of the content display device 3. The following description will be given on the assumption that the information processing terminal 4 is functioning as a second screen of the content display device 3.

In addition, the following description will be given by assuming the configuration in which the advertisement delivery device 2 delivers an additional advertisement to one or both of the content display device 3 and the information processing terminal 4 instead of the configuration in which the content display device 3 outputs the obtained additional advertisement to the information processing terminal 4 that is functioning as the second screen. Note that a configuration is also allowed in which the content display device 3 outputs the additional advertisement obtained from the advertisement delivery device 2 to the information processing terminal 4 as a result of the content display device 3 performing a process described below.

In the case where the content display device 3 includes the image capturing unit, the advertisement delivery device 2 according to the second embodiment determines whether to deliver an additional advertisement on the basis of viewing-related information and further determines which of the content display device 3 and the information processing terminal 4 the additional advertisement is to be delivered to on the basis of whether the user is looking away from the display device 34 of the content display device 3 (for example, the case where eyes are not detectable from an image captured by the image capturing unit or the case where the eyes are directed in a direction that is different from a direction of the image capturing unit when the direction of the eyes are detected from the captured image).

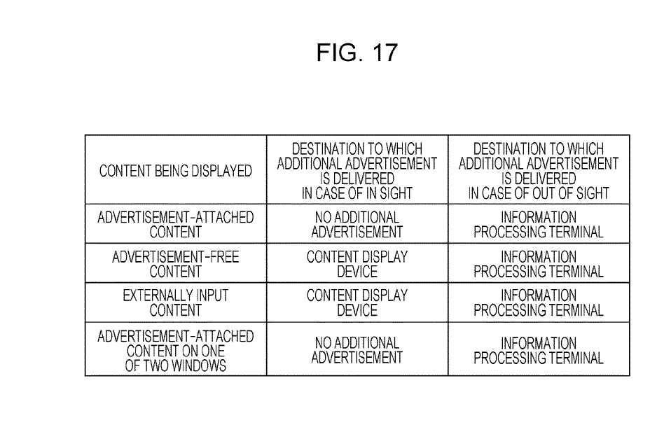

Now, a destination to which the advertisement delivery device 2 delivers an advertisement when the user looks away from the content display device 3 is described with reference to FIG. 17. FIG. 17 is a diagram illustrating an example of a list of destinations to which the advertisement delivery device 2 delivers an advertisement when the user looks away from the content display device 3. FIG. 17 describes the case where content is displayed only on the content display device 3 for convenience of explanation. As illustrated in FIG. 17, when advertisement-attached content is displayed on the content display device 3, the advertisement delivery device 2 does not deliver an additional advertisement if the user is looking at the content display device 3 (in case of in sight in FIG. 17) and delivers an additional advertisement to the information processing terminal 4 if the user looks away from the content display device 3 (in case of out of sight in FIG. 17). In this way, the advertisement delivery device 2 successfully delivers an additional advertisement to the information processing terminal 4 while the user of the content display device 3 is not viewing advertisement-attached content. As a result, the right-related risk described in FIG. 16 is successfully avoided.

In addition, when advertisement-free content is displayed on the content display device 3, the advertisement delivery device 2 delivers an additional advertisement to the content display device 3 if the user is looking at the content display device 3 and delivers the additional advertisement to the information processing terminal 4 if the user looks away from the content display device 3. In this way, the advertisement delivery device 2 successfully changes the delivery destination in accordance with the user's line of sight with respect to the content display device 3. As a result, the additional advertisement is successfully kept recognized by the user regardless of whether the user is viewing the advertisement-free content or not.

In addition, when externally input content is displayed on the content display device 3, the advertisement delivery device 2 delivers an additional advertisement to the content display device 3 if the user is looking at the content display device 3 and delivers the additional advertisement to the information processing terminal 4 if the user looks away from the content display device 3. In this way, the advertisement delivery device 2 successfully changes the delivery destination in accordance with the user's line of sight with respect to the content display device 3. As a result, the additional advertisement is successfully kept recognized by the user regardless of whether the user is viewing the externally input content or not.

In addition, when the screen of the content display device 3 is set in a two split window mode and advertisement-attached content is displayed in one of the two windows, the advertisement delivery device 2 does not deliver an additional advertisement if the user is looking at the content display device 3 and delivers the additional advertisement to the information processing terminal 4 if the user looks away from the content display device 3. In this way, the advertisement delivery device 2 successfully delivers an additional advertisement to the information processing terminal 4, for example, while the user of the content display device 3 is not viewing advertisement-attached content. As a result, the right-related risk described in FIG. 16 is successfully avoided.

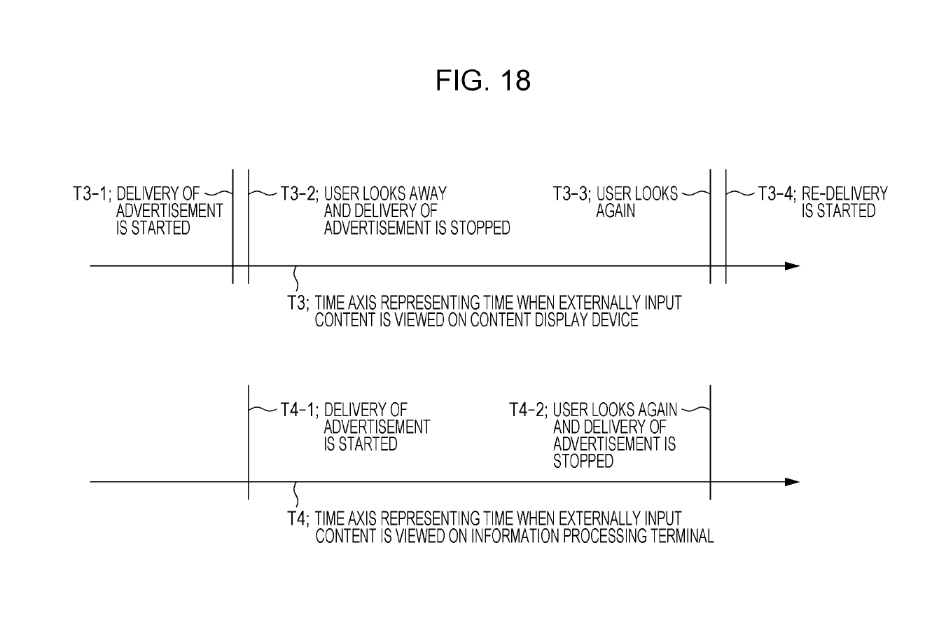

Now, the flow of control in which the advertisement delivery device 2 delivers an advertisement to the content display device 3 and the information processing terminal 4 in accordance with the user's line of sight is described with reference to FIG. 18. FIG. 18 is a diagram illustrating an example of the flow of control in which the advertisement delivery device 2 delivers an advertisement to the content display device 3 and the information processing terminal 4 in accordance with the user's line of sight. FIG. 18 is a diagram illustrating an example of the flow of control in which the advertisement delivery device 2 delivers an advertisement to the content display device 3 and the information processing terminal 4 in accordance with the user's line of sight. In FIG. 18, a time axis T3 is a time axis representing time that passes in the content display device 3.

In addition, in FIG. 18, a time axis T4 is a time axis representing time that passes in the information processing terminal 4. The following description will be given on the assumption that the origin of the time axis T3 matches the origin of the time axis T4.

For example, the content display device 3 assumes that delivery of an additional advertisement from the advertisement delivery device 2 is started at timing T3-1. Then, at timing T3-2, the advertisement delivery device 2 determines that the user looks away from the display unit 34 of the content display device 3 on the basis of the viewing-related information, and consequently stops delivering the additional advertisement to the content display device 3. At that time, the advertisement delivery device 2 starts delivering the additional advertisement to the information processing terminal 4 at timing T4-1 (substantially the same timing as the timing T3-1).

Thereafter, at timing T4-2 (substantially the same timing as timing T3-3), the advertisement delivery device 2 determines that the user looks away from the display unit 34 of the content display device 3 and consequently stops delivering the additional advertisement to the information processing terminal 4. In addition, the advertisement delivery device 2 starts re-delivery of the additional advertisement to the content display device 3 at timing T3-4 since it determines that the user looks away from the display unit 34 of the content display device 3 at the timing T3-3 (substantially the same timing as the timing T4-2).

As described above, in the advertisement delivery system 1 according to the second embodiment, the viewing-related information includes information indicating the user's line of sight with respect to the display unit 34 of the content display device 3, and delivery of an additional advertisement is controlled on the basis of the information indicating the user's line of sight. In this way, the advertisement delivery system 1 successfully obtains advantageous effects similar to those of the first embodiment and further successfully delivers an additional advertisement to different destinations depending on whether the user is viewing the content display device 3 or not.

### Third Embodiment

A third embodiment of the present invention will be described below with reference to the drawing. Substantially the same functional units as those according to the first embodiment are denoted by the same reference signs, and a description thereof is omitted. The content display device 3 of the advertisement delivery system 1 according to the third embodiment is configured as follows. The content display device 3 or the information processing terminal 4 detects whether the user is out on the basis of whether the information processing terminal 4 is connected to a predetermined access point, and the content display device 3 includes information indicating whether the user is out in the viewing-related information. The following description will be given on the assumption that the content display device 3 detects whether the user is out on the basis of whether the information processing terminal 4 is connected to a predetermined access point. Instead of this configuration, the information processing terminal 4 may detect whether the user is out on the basis of whether the information processing terminal 4 is connected to a predetermined access point. In such a case, the information processing terminal 4 outputs the detection result to the content display device 3.

In addition, the following description will be given by assuming the configuration in which the advertisement delivery device 2 delivers an additional advertisement to one or both of the content display device 3 and the information processing terminal 4 instead of the configuration in which the content display device 3 outputs the obtained additional advertisement to the information processing terminal 4 that is functioning as the second screen. Note that a configuration is also allowed in which the content display device 3 outputs the additional advertisement obtained from the advertisement delivery device 2 to the information processing terminal 4 as a result of the content display device 3 performing a process described below.

The advertisement delivery device 2 according to the second embodiment determines whether to deliver an additional advertisement on the basis of the viewing-related information and also determines which of the content display device 3 and the information processing terminal 4 the additional advertisement is to be delivered to on the basis of whether the user is out or not.

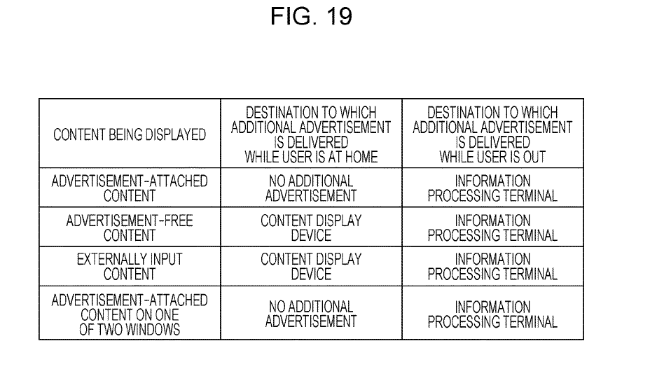

Now, a destination to which the advertisement delivery device 2 delivers an advertisement when the user is out is described with reference to FIG. 19. FIG. 19 is a diagram illustrating an example of a list of destinations to which the advertisement delivery device 2 delivers an advertisement when the user is out. As illustrated in FIG. 19, when advertisement-attached content is displayed on the content display device 3, the advertisement delivery device 2 does not deliver an additional advertisement if the user is at home (while the user is at home in FIG. 19) and delivers the additional advertisement to the information processing terminal 4 if the user is out (while the user is out in FIG. 19). In this way, the advertisement delivery device 2 successfully delivers an additional advertisement to the information processing terminal 4 while the user of the content display device 3 is not viewing advertisement-attached content. As a result, the right-related risk described in FIG. 16 is successfully avoided.

In addition, when advertisement-free content is displayed on the content display device 3, the advertisement delivery device 2 delivers an additional advertisement to the content display device 3 if the user is at home and delivers the additional advertisement to the information processing terminal 4 if the user is out. In this way, the advertisement delivery device 2 successfully changes the delivery destination depending on whether the user of the content display device 3 is at home or is out. As a result, the additional advertisement is successfully kept recognized by the user regardless of whether the user is viewing the advertisement-free content or not.

In addition, when externally input content is displayed on the content display device 3, the advertisement delivery device 2 delivers an additional advertisement to the content display device 3 if the user is at home and delivers the additional advertisement to the information processing terminal 4 if the user is out. In this way, the advertisement delivery device 2 successfully changes the delivery destination depending on whether the user of the content display device 3 is at home or is out. As a result, the additional advertisement is successfully kept recognized by the user regardless of whether the user is viewing the externally input content or not.

Further, when the screen of the content display device 3 is set in a two split window mode and advertisement-attached content is displayed on one of the two windows, the advertisement delivery device 2 does not deliver an additional advertisement if the user is at home and delivers the additional advertisement to the information processing terminal 4 if the user is out. In this way, the advertisement delivery device 2 successfully delivers an additional advertisement to the information processing terminal 4, for example, while the user of the content display device 3 is not viewing advertisement-attached content. As a result, the right-related risk described in FIG. 16 is successfully avoided.

As described above, in the advertisement delivery system 1 according to the third embodiment, the viewing-related information includes information indicating whether the user of the content display device 3 is out of a room where the content display device 3 is located, and delivery of an additional advertisement is controlled on the basis of the information indicating whether the user is out. In this way, the advertisement delivery system 1 successfully obtains advantageous effects similar to those of the first embodiment and further successfully gives a larger advertising effect on the user by delivering the additional advertisement to the information processing terminal 4 even if the user is out.

### Fourth Embodiment

A fourth embodiment of the present invention will be described below with reference to the drawings. Substantially the same functional units as those according to the first embodiment are denoted by the same reference signs, and a description thereof is omitted. The content display device 3 of the advertisement delivery system 1 according to the fourth embodiment includes, for example, an image capturing unit that captures an image of a range including content displayed on the display unit 34 and outputs, to the advertisement delivery device 2, viewing-related information including the captured image of the range obtained by the image capturing unit.

The advertisement delivery device 2 obtains the captured image, obtains for example still images of all the contents that were broadcast at the time when the captured image was captured from the content information server 6, and extracts a still image that matches the image displayed on the content display device 3 in the obtained captured image from among the obtained still images of all the contents. By performing this extraction, the advertisement delivery device 2 successfully controls delivery of an additional advertisement as in the first embodiment even if the content display device 3 is incapable of obtaining, via a network, information for identifying content displayed on the content display device 3 or the like included in the viewing-related information.

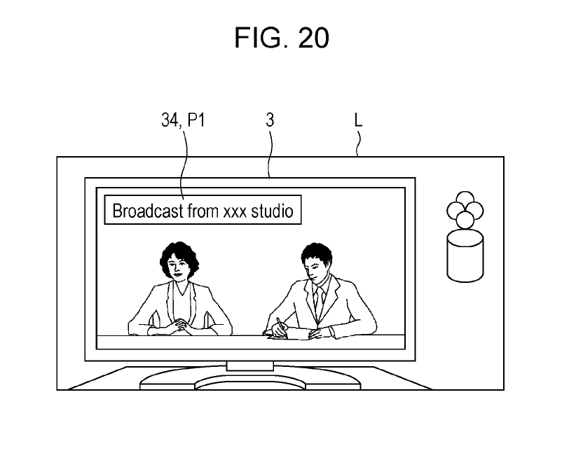

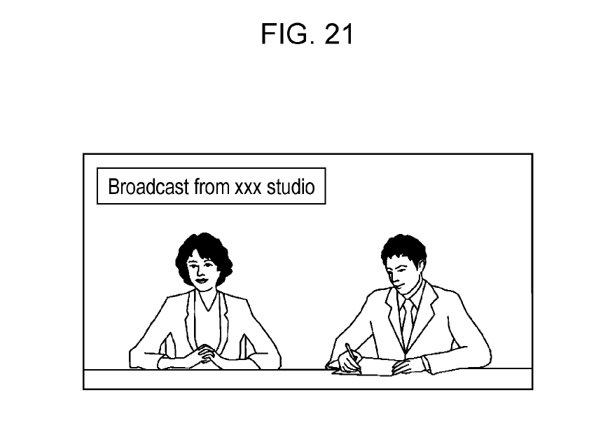

Now, an image displayed on the content display device 3 in the captured image and a still image of the content that was broadcast at the time when the captured image was captured are described with reference to FIGS. 20 and 21. FIG. 19 is a diagram illustrating an image displayed on the content display device 3 in the captured image and a still image of the content that was broadcast at the time when the captured image was captured. FIG. 20 illustrates an example of an image displayed on the content display device 3 in a captured image. FIG. 21 illustrates an example of a still image of the content that was broadcast at the time when the captured image illustrated in FIG. 20 was captured.

As illustrated in FIG. 20, a captured image L includes an image of the display unit 34 of the content display device 3 that displays an image P1. Upon obtaining viewing-related information including the captured image illustrated in FIG. 20, the advertisement delivery device 2 detects the display unit 34 from the obtained captured image by using techniques, such as pattern matching and edge detection. Then, the advertisement delivery device 2 extracts the image P1 displayed on the detected display unit 34.

The advertisement delivery device 2 further obtains, from the content information server 6, still images of all the contents that were broadcast at the time when the captured image illustrated in FIG. 20 was captured. Then, the advertisement delivery device 2 extracts a still image (still image illustrated in FIG. 21) that matches the extracted image P1 from among the still images of all the contents. The advertisement delivery device 2 obtains content information of the content relating to the extracted still image from the content information server 6 and controls delivery of an additional advertisement on the basis of the obtained content information.

As described above, in the advertisement delivery system 1 according to the fourth embodiment, delivery of an additional advertisement is controlled on the basis of a captured image of a range including the display unit 34 of the content display device 3. In this way, the advertisement delivery system 1 successfully obtains advantageous effects similar to those of the first embodiment and further successfully controls delivery of an additional advertisement as in the first embodiment even if the content display device 3 is incapable of obtaining, via a network, information for identifying content displayed on the content display device 3 or the like included in viewing-related information.

### Fifth Embodiment

A fifth embodiment of the present invention will be described below with reference to the drawings. Substantially the same components as those according to the above-described embodiments are denoted by the same reference signs, and a description thereof is omitted.

An advertisement delivery system 1D according to this embodiment is a system that controls delivery of an advertisement to the content display device 3 just like the advertisement delivery system 1D according to the first embodiment. In this embodiment, how delivery of an advertisement is controlled will be described in more detail.

First, the configuration of the advertisement delivery system 1D will be described.

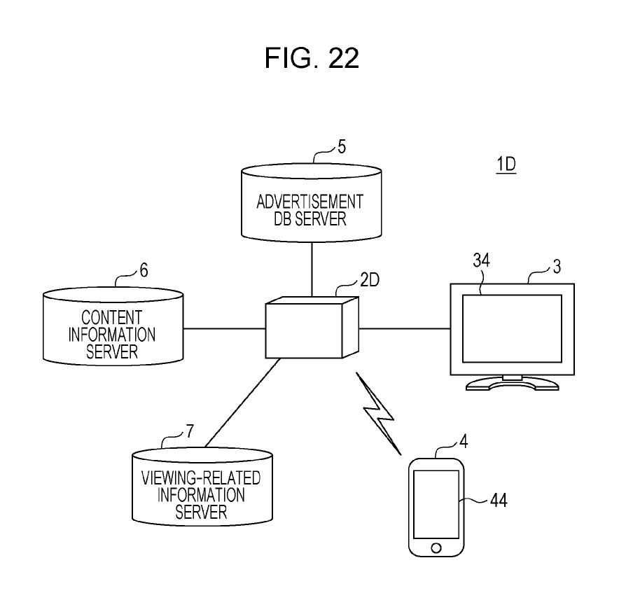

FIG. 22 is a diagram illustrating an example of the configuration of the advertisement delivery system 1D according to this embodiment.

The advertisement delivery system 1D includes an advertisement delivery device 2D in place of the advertisement delivery device 2 included in the advertisement delivery system 1. In addition, the advertisement delivery system 1D further includes a viewing-related information server 7 in addition to the devices included in the advertisement delivery system 1.

The advertisement delivery device 2D is a device that control delivery of an advertisement on the basis of permission/denial information and viewing-related information. The permission/denial information is information that associates an advertisement delivery condition with information regrading content. That is, the permission/denial information is information indicating whether delivery of an advertisement is permitted or not depending on content. For example, the above-described advertisement presence/absence information is an example of the permission/denial information. Details of the permission/denial information will be described later. In addition, the case where the advertisement delivery condition is a condition on which an advertisement is not delivered will be mainly described below by way of example.

The advertisement delivery device 2D determines whether to deliver an advertisement selected for each content display device 3, for example. In this way, the advertisement delivery device 2D successfully cancels delivery of the advertisement. Thus, the advertisement delivery system 1D successfully prevents an inappropriate advertisement from being delivered to the content display device 3 or the like.

Cancelling delivery of an advertisement may include skipping delivery of a delivery candidate advertisement, not selecting an advertisement for which delivery is cancelled as the delivery candidate, replacing an advertisement to be delivered with another advertisement, and not reproducing a delivered advertisement, for example. The case where delivery of an advertisement is cancelled by skipping delivery of the delivery candidate advertisement will be described below by way of example.

In addition, whether to cancel delivery of an advertisement can be determined on the basis of; for example, the sponsor associated with content, the distributor of the content, the producer of the content, or the type of the content. For example, by determining whether to cancel delivery of an advertisement on the basis of the sponsor associated with content, delivery of an advertisement of an advertiser that competes against the sponsor of the content is successfully prevented. That is, when content is displayed on the content display device 3, a situation where an advertisement of an advertiser that competes against the sponsor of the content is displayed is successfully prevented. In addition, for example, by performing the determination on the basis of the distributor of content, an advertisement is successfully delivered only when content of a specific distributor is displayed and delivery of an advertisement is successfully cancelled when content of other distributors is displayed. In addition, for example, by performing the determination on the basis of the type of content, an advertisement is successfully delivered when externally input content is displayed on the content display device 3 and delivery of an advertisement is successfully cancelled when broadcast content is displayed.

The case of determining whether delivery of an advertisement is permitted on the basis of the sponsor associated with content will be described below by way of example. Specifically, the description is given of the case where the advertiser of the advertisement being a competitor of the sponsor associated with the content displayed on the content display device 3 is used as the condition on which the advertisement is not delivered. In addition, the case of displaying broadcast content will be described below by way of example although the content display device 3 may reproduce any given content, such as externally input content.

The viewing-history information server 7 is a server device that accumulates viewing-related information transmitted from the content display device 3. The viewing-related information is managed for each content display device 3 that is the transmission source or for each user of the content display device 3. The viewing-related information server 7 transmits, in response to a request from the advertisement delivery device 2D, the viewing-related information managed thereby to the advertisement delivery device 2D that is the requesting source.

In addition, the advertisement DB server 5 according to this embodiment stores the permission/denial information in advance.

Specific examples of the data structure of various kinds of information used by the advertisement delivery system 1D according to this embodiment will be described next.

First, content information will be described.

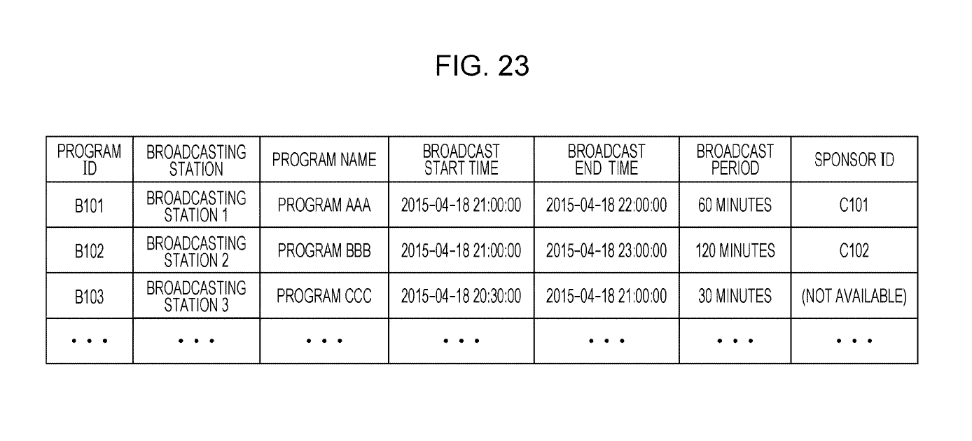

FIG. 23 is a diagram illustrating an example of the data structure of the content information.

In this embodiment, each record of the content information includes a program ID (program ID in FIG. 23), a broadcast ID (broadcasting station in FIG. 23), program name information (program name in FIG. 23), broadcast start time information (broadcast start time in FIG. 23), broadcast end time information (broadcast end time in FIG. 23), broadcast period information (viewing period in FIG. 23), and a sponsor ID (sponsor ID in FIG. 23) that are associated with one another.

The program ID is information for identifying a program. That is, the program ID is an example of content identification information for identifying content.

The broadcast ID is information for identifying a broadcasting station. That is, the broadcast ID is an example of information indicating the distributor of content. The content information may include information indicating the producer of content instead of information indicating the distributor of the content. In addition, the content information may include both of information indicating the distributor of content and information indicating the producer of the content.

The program name information is information indicating the name of the program. That is, the program name information is an example of the content identification information for identifying the content.

The broadcast start time information is information indicating the broadcast start time of the content.

The broadcast end time information is information indicating the broadcast end time of the content.

The broadcast period information is information indicating a broadcast period of the content. That is, the broadcast period information is information indicating duration of the content.

Note that one of the broadcast start time information, the broadcast end time information, and the broadcast period information may be omitted. Even in such a case, the omitted information is successfully determined from the remaining two pieces of information that are not omitted. For example, when the broadcast end time information is omitted, the broadcast end time information is successfully determined by adding the broadcast period of the content indicated by the broadcast period information to the broadcast start time indicated by the broadcast start time information.

The sponsor ID is information indicating the sponsor associated with the content. The sponsor associated with content may be, for example, the producer of the content, the distributor of the content, or the sponsor of the content. There may be no sponsor associated with content, such as in the case where a state-run broadcasting station is the distributor of content, for example. In addition, there may be a plurality of sponsors associated with content. Thus, one or more sponsor IDs are included in some cases, and no sponsor ID is included in some cases.

As described above, each record of the content information includes information such as the distributor or producer of content, the name of the content, the broadcast time of the content, the duration of the content, and the sponsor of the content. That is, the content information is an example of meta information of content.

The above is the description of the data structure of the content information.

The viewing-related information will be described next.

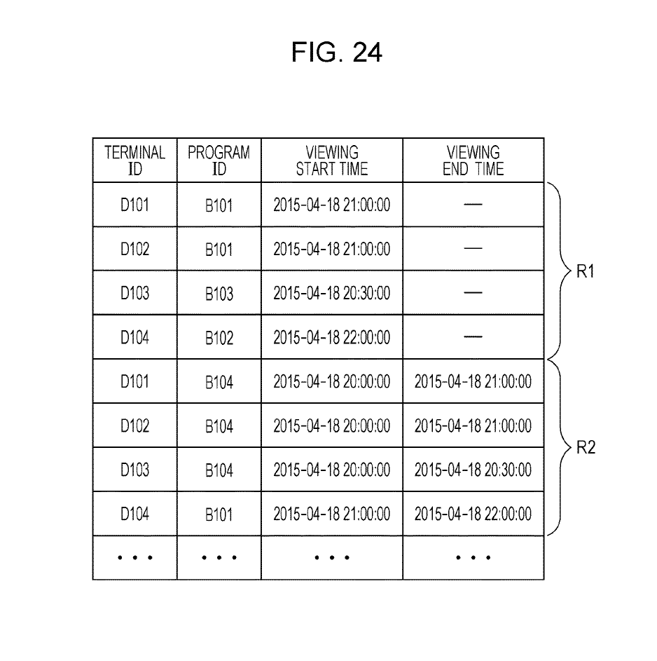

FIG. 24 is a diagram illustrating an example of the data structure of the viewing-related information.

The viewing-related information according to this embodiment is, for example, information representing a content viewing history for the content display device 3. In this embodiment, each record of the viewing-related information includes a terminal ID (terminal ID in FIG. 24), a program ID (program ID in FIG. 24), viewing start time information (viewing start time in FIG. 24), and viewing end time information (viewing end time in FIG. 24) which are associated with one another.

The terminal ID is information for identifying the content display device 3. That is, the terminal ID is an example of information for identifying a user of the content display device 3. Identification information of the user of the content display device 3 may be used instead of or in addition to the terminal ID.

The program ID is information for identifying a program as described above.

The viewing start time information is information indicating the time at which viewing of the content was started using the content display device 3. Viewing content is equivalent to, for example, the content display device 3 displaying (reproducing) content, the user looking at the content display device 3 when the content is displayed on the content display device 3, or the user being in a space (e.g., room) where the content display device 3 is located when the content is displayed on the content display device 3.

The viewing end time information is information indicating the time at which viewing of the content using the content display device 3 was finished. The viewing-related information according to this embodiment includes two types, i.e., current viewing-related information and past viewing-related information, in accordance with the value of the viewing end time information.

The current viewing-related information is viewing-related information about content currently displayed on the content display device 3. That is, the current viewing-related information indicates that the user of the content display device 3 is viewing the content. The current viewing-related information does not contain the viewing end time as the viewing end time information since viewing of the content has not been finished. In the case of the example illustrated in FIG. 24, four records R1 registered at the first to fourth rows are records of the current viewing-related information. The advertisement delivery device 2D successfully identifies content that is displayed on the content display device 3 by referring to the current viewing-related information. The advertisement delivery device 2D may refer to viewing-related information that satisfies a predetermined period-related condition, such as the time indicated by the viewing start time information being 10 minutes ago or more or being in a period from 10 minutes ago to one hour ago, in order to identify the content that is displayed on the content display device 3. In this way, the advertisement delivery device 2D successfully identifies the user who keeps viewing the same content for a predetermined period or longer.

The past viewing-related information is viewing-related information about content that was displayed on the content display device 3 in the past. That is, the past viewing-related information indicates that the user of the content display device 3 finished viewing the content. The past viewing-related information contains the viewing end time as the viewing end time information since viewing of the content has been finished. In the case of the example illustrated in FIG. 24, four records R2 registered at the fifth to eighth rows are records of the current viewing-related information.

That is, the viewing end time information according to this embodiment is also information indicating whether viewing of the content is finished, i.e., whether the content is being viewed now.

How a record of the viewing-related information is updated will be described next. Here, the case where the user of the content display device 3 changes the channel while viewing content will be described by way of example.

In this case, the time at which the channel is changed is stored as the viewing end time information in a record of the content viewed before the channel change. In addition, a new record is created for content viewed after the channel change. In addition to the program ID or the like indicating the content viewed after the channel change, the time at which the channel is changed is stored as the viewing start time information in this record. Accordingly, the viewing end time information of each record of the viewing-related information is not limited to the time at which broadcast of the content ends (ended) and may indicate the time at which the user of the content display device 3 finished viewing the content.

As described above, each record of the viewing-related information includes information, such as identification information of content displayed on the content display device 3 and time relating to viewing of the content.

The above is the description of the data structure of the viewing-related information.

The permission/denial information will be described next.

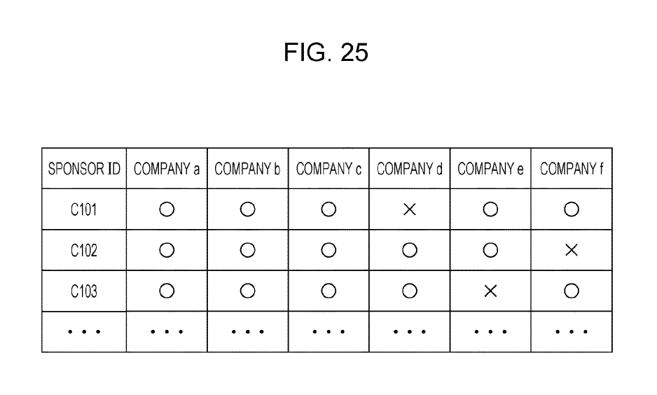

FIG. 25 is a diagram illustrating an example of the data structure of the permission/denial information.

In this embodiment, each record of the permission/denial information includes a sponsor ID (sponsor ID in FIG. 25) and advertisement permission/denial information for each advertiser (each of company a, company b, company c, company d, company e, and company f in FIG. 25) that are associated with each other.

The sponsor ID is information indicating the sponsor associated with content as described above.

The advertisement permission/denial information for each advertiser is information indicating whether to permit delivery of an advertisement of each company that is the advertiser. That is, the advertisement permission/denial information is an example of a condition on which an advertisement is not delivered. In the example illustrated in FIG. 25, “◯” is stored when delivery of an advertisement is permitted, and “x” is stored when delivery of an advertisement is not permitted.

As described above, each record of the permission/denial information indicates, for each sponsor associated with content, whether delivery of an advertisement of each company is permitted when the content is displayed on the content display device 3. That is, the permission/denial information is information that associates content with permission/denial of delivery of an advertisement. In the example illustrated in FIG. 25, permission/denial of delivery of an advertisement and content are associated with each other through the sponsor associated with the content. Accordingly, the permission/denial information may indirectly associate permission/denial of delivery of an advertisement and content with each other or may directly associate them with each other.

The above is the description of the permission/denial information.

An operation of the advertisement delivery system 1D will be described next.

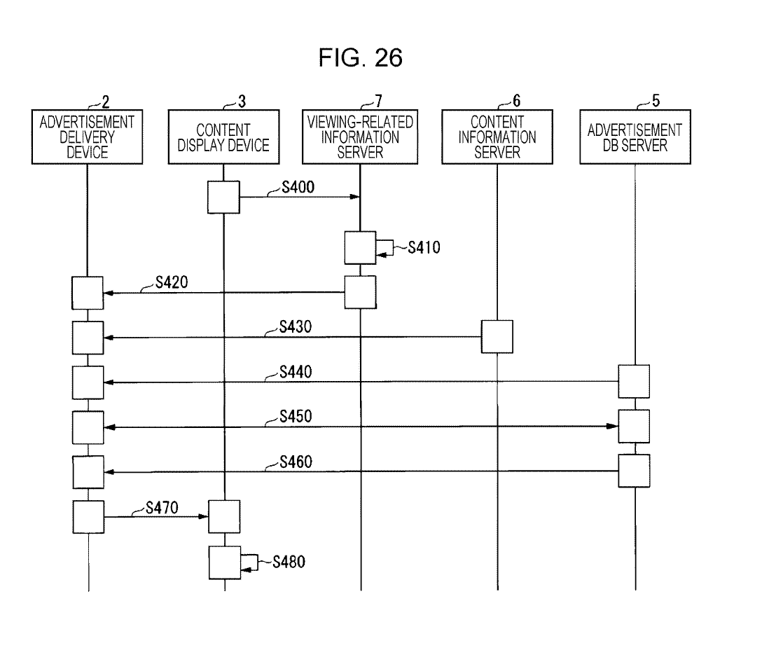

FIG. 26 is a sequence diagram illustrating an example of the flow of an overall process performed by the advertisement delivery system 1D.

First, the output control unit 363 of the content display device 3 transmits viewing-related information about content displayed on the content display device 3 to the viewing-related information server 7 (step S400). The viewing-related information is transmitted, for example, when display of the content is started and when display of the content is ended. Display of the content is started or ended, for example, when the content display device 3 is powered on or off, when the broadcast channel is switched, or when display is switched to externally input content. Upon obtaining the viewing-related information from the content display device 3, the viewing-related information server 7 stores and accumulates the obtained viewing-related information in a storage unit thereof (step S410). This processing of steps S400 and S410 may be performed at any time asynchronously with other processing illustrated in FIG. 26.

On the other hand, the first obtaining unit 263 of the advertisement delivery device 2D obtains, from the viewing-related information server 7, the viewing-related information regarding the content display device 3 to which an advertisement is to be delivered (step S420). At that time, the advertisement delivery device 2D obtains the current viewing-related information.

Then, the content information obtaining unit 265 of the advertisement delivery device 2D obtains content information from the content information server 6 (step S430). At that time, the content delivery device 2D obtains content information regarding content that is expected to be currently displayed on the content display device 3 by referring to the current viewing-related information obtained through the processing of step S420.

Then, the delivery control unit 267 of the advertisement delivery device 2D identifies the sponsor associated with the content by referring to the content information obtained through the processing of step S430. Then, the second obtaining unit 265 of the advertisement delivery device 2D obtains permission/denial information for the identified sponsor from the advertisement DB server 5 (step S440).

Then, the delivery control unit 267 of the advertisement delivery device 2D determines whether delivery of an advertisement is permitted on the basis of the permission/denial information obtained through the processing of step S440 (step S450). First, the delivery control unit 267 of the advertisement delivery device 2D selects a delivery candidate advertisement. Then, the delivery control unit 267 of the advertisement delivery device 2D identifies the advertiser of the selected advertisement. Then, the delivery control unit 267 of the advertisement delivery device 2D determines whether delivery of an advertisement of the identified advertiser is permitted by referring to the permission/denial information. If delivery of the advertisement is not permitted, the advertisement delivery device 2D cancels delivery of the advertisement. If delivery of the advertisement is permitted, the advertisement obtaining unit 261 of the advertisement delivery device 2D obtains the advertisement from the advertisement DB server 5 (step S460).

Note that the delivery candidate advertisement may be selected by using any given method. For example, the advertisement delivery device 2D may estimate the preference or interest of the user of the content display device 3 on the basis of the past viewing-related information and may select an advertisement that is likely to draw the user's interest. In this case, the preference or interest of the user may be estimated from, for example, the content viewing time, the genre, the cast, or the target users of the content. In addition, for example, the advertisement delivery device 2D may select an advertisement on the basis of the attribute of the user.

After the processing of step S460, the delivery control unit 267 of the advertisement delivery device 2D delivers the advertisement obtained through the processing of step S460 to the content display device 3 (step S470). Then, the third obtaining unit 363 of the content display device 3 obtains the advertisement from the advertisement delivery device 2D. Then, the display control unit 365 of the content display device 3 displays the obtained advertisement (step S480).

The above is the description of the flow of the overall process performed by the advertisement delivery system 1D.

As described above, the advertisement delivery system 1D according to this embodiment performs or cancels delivery of an advertisement in accordance with content expected to be currently viewed on the content display device 3. In this way, the advertisement delivery system 1D successfully cancels delivery of an advertisement that is inappropriate to deliver and successfully delivers an appropriate advertisement. Specifically, the advertisement delivery system 1D successfully cancels delivery of an advertisement that is inappropriate to deliver, for example, because of a relationship between the advertiser and the sponsor associated with the content, the distributor of the content, or the producer of the content and successfully delivers an advertisement only in the case of externally input content.

The case of determining whether to permit delivery of an advertisement on the basis of the sponsor associated with content has been described in the fifth embodiment above; however, the information referred to is not limited to this information.

For example, the advertisement delivery system 1D may determine whether delivery of an advertisement is permitted on the basis of the type of content. Specifically, the advertisement delivery system 1D may determine whether delivery is permitted, for example, on the basis of whether the displayed content is advertisement-attached content or advertisement-free content. In this case, the permission/denial information includes an association between advertisement-attached content and denial of delivery and an association between advertisement-free content and permission of delivery, for example. That is, the displayed content being advertisement-attached content is set as the condition on which an advertisement is not delivered, and the permission/denial information associates this condition with information indicating whether the content is advertisement-attached content.

In addition, the advertisement delivery system 1D may determine whether to permit an advertisement, for example, on the basis of whether the displayed content is broadcast content or externally input content. The permission/denial information includes an association between broadcast content and denial of delivery and an association between externally input content and permission of delivery. That is, the displayed content being broadcast content is set as the condition on which an advertisement is not delivered, and the permission/denial information associates this condition with information indicating whether the content is broadcast content.

In addition, the advertisement delivery system 1D may determine whether delivery of an advertisement is permitted, for example, on the basis of the distributor of content. In this case, the permission/denial information includes an association between a specific broadcasting station and permission of delivery and an association between other broadcasting stations and denial of delivery for example. That is, the distributor of the content not being the specific broadcasting station is set as the condition on which an advertisement is not delivered, and the permission/denial information associates this condition with information indicating whether the content is broadcast content.

In addition, the case where the condition on which an advertisement is not delivered is set has been described in the fifth embodiment above; however, a condition on which an advertisement is delivered may be determined instead of the condition on which an advertisement is not delivered. Specifically, for example, the advertiser being a group company of the sponsor associated with content may be set as the condition on which an advertisement is delivered. In addition, the condition on which an advertisement is not delivered or the condition on which an advertisement is delivered may be any given combination of various conditions described above or may be changed in a given manner.

In addition, any given component(s) in the above-described embodiments may be separately included in different devices. In addition, a plurality of components may be combined and included in a single device. For example, the process for controlling delivery of an advertisement performed by the advertisement delivery system 1D according to the fifth embodiment may be applied to the advertisement delivery system 1 according to the first to fourth embodiments.

While the embodiments of this invention have been described in detail with reference to the drawings above, the specific configuration is not limited to these embodiments and the configuration may be modified, replaced, or removed as long as the resulting configuration does not depart from the essence of this invention.

In addition, programs for implementing the functions of the individual units of the advertisement delivery device 2 or 2D, the content display device 3, the information processing terminal 4, the advertisement DB server 5, the content information server 6, and the viewing-related information server 7 according to the above embodiments may be stored on a computer-readable recording medium, and a computer system may load and execute the programs stored on this recording medium. In this way, the advertisement delivery device 2, the content display device 3, and the information processing terminal 4 may be implemented. The “computer system” used therein includes an OS (Operation System) and hardware such as peripheral devices.

In addition, the “computer system” includes a website-provided environment (or display environment) if the WWW system is utilized.

In addition, the “computer-readable recording medium” refers to a portable medium such as a flexible disk, a magneto-optical disk, a ROM, or a CD-ROM or a storage device such as a hard disk built in the computer system. Further, the “computer-readable recording medium” includes a medium that dynamically holds a program for a short period of time, such as a communication line of the case where the program is transmitted via a network such as the Internet or a communication line such as a telephone line, and a medium that holds a program for a predetermined period, such as a volatile memory included in a computer system serving as the server or the client in the above case. In addition, the aforementioned programs may be programs for implementing some of the above-described functions or may be programs that can implement the above-described functions when being combined with a program already stored in the computer system.

(1) An aspect of the present invention is an advertisement delivery device including: a first obtaining unit that obtains, as viewing-related information, information relating to viewing on a content display device; and a delivery control unit that controls delivery of an advertisement on the basis of the obtained viewing-related information.
(2) Another aspect of the present invention is the advertisement delivery device according to (1), wherein the delivery control unit determines whether to deliver an advertisement on the basis of the viewing-related information and does not deliver the advertisement if the delivery control unit determines not to deliver the advertisement.
(3) Another aspect of the present invention is the advertisement delivery device according to (1) or (2), further including a second obtaining unit that obtains, as advertisement presence/absence information, information indicating whether an advertisement is present for content displayed on the content display device, wherein the delivery control unit controls delivery of the advertisement further on the basis of the obtained advertisement presence/absence information.
(4) Another aspect of the present invention is the advertisement delivery device according to (3), wherein the delivery control unit does not deliver the advertisement if the obtained advertisement presence/absence information indicates that an advertisement is present.
(5) Another aspect of the present invention is the advertisement delivery device according to any one of (1) to (4), wherein the viewing-related information includes information indicating content displayed on the content display device.
(6) Another aspect of the present invention is the advertisement delivery device according to any one of (1) to (5), wherein the viewing-related information includes information indicating that the content display device is powered on or off.
(7) Another aspect of the present invention is the advertisement delivery device according to any one of (1) to (6), wherein the viewing-related information includes information indicating whether content is displayed on the content display device via an external input terminal or the Internet.
(8) Another aspect of the present invention is the advertisement delivery device according to any one of (1) to (7), wherein the delivery control unit delivers the advertisement to an information processing terminal that functions as a second screen of the content display device when a user of the content display device looks away from the content display device.
(9) Another aspect of the present invention is the advertisement delivery device according to any one of (1) to (8), wherein the delivery control unit delivers the advertisement to an information processing terminal that functions as a second screen of the content display device when a user of the content display device is out of a room where the content display device is located.
(10) Another aspect of the present invention is the advertisement delivery device according to any one of (1) to (9), wherein the delivery control unit controls delivery of the advertisement on the basis of a captured image including a display unit of the content display device.
(11) Another aspect of the present invention is an advertisement delivery method including: obtaining, as viewing-related information, information relating to viewing on a content display device; and controlling delivery of an advertisement on the basis of the obtained viewing-related information.
(12) Another aspect of the present invention is an advertisement delivery program causing a computer of an advertisement delivery device to: obtain, as viewing-related information, information relating to viewing on a content display device; and control delivery of an advertisement on the basis of the obtained viewing-related information.
(13) Another aspect of the present invention is an advertisement delivery system including: an advertisement delivery device; and a content display device that displays an advertisement delivered from the advertisement delivery device, wherein the advertisement delivery device includes a first obtaining unit that obtains, as viewing-related information, information relating to viewing on a content display device, a delivery control unit that controls delivery of an advertisement on the basis of the obtained viewing-related information, and a delivery unit that delivers the advertisement in response to a request from the delivery control unit, and wherein the content display device includes an output unit that outputs the viewing-related information thereof, a third obtaining unit that obtains the advertisement delivered from the advertisement delivery device, and a display unit that displays the obtained advertisement.
(14) Another aspect of the present invention is an advertisement delivery system including: an advertisement delivery device; a content display device, and an information processing terminal that displays an advertisement output from the advertisement delivery device, wherein the advertisement delivery device includes a first obtaining unit that obtains, as viewing-related information, information relating to viewing on a content display device, a delivery control unit that controls delivery of an advertisement on the basis of the obtained viewing-related information, and a delivery unit that delivers the advertisement in response to a request from the delivery control unit, wherein the content display device includes a first output unit that outputs the viewing-related information thereof, a third obtaining unit that obtains the advertisement delivered from the advertisement delivery device, and a second output unit that outputs the obtained advertisement to the information processing terminal, and wherein the information processing terminal includes a fourth obtaining unit that obtains the advertisement from the content display device and a display unit that displays the obtained advertisement.
(15) Another aspect of the present invention is a content display device including: a first output unit that outputs information indicating a viewing-related state on the content display device; and a display unit that displays an advertisement that is delivered in response to a request from a delivery control unit as a result of the information relating to viewing on the content display device being obtained as viewing-related information and the delivery control unit controlling delivery of the advertisement on the basis of the obtained viewing-related information.
(16) Another aspect of the present invention is a content display program causing a computer of a content display device to: output information indicating a viewing-related state on the content display device; and display an advertisement that is delivered in response to a request from a delivery control unit as a result of the information relating to viewing on the content display device being obtained as viewing-related information and the delivery control unit controlling delivery of the advertisement on the basis of the obtained viewing-related information.
(17) Another aspect of the present invention is an information processing terminal including: a fourth obtaining unit that obtains an advertisement which is delivered in response to a request from a delivery control unit as a result of information relating to viewing on a content display device being obtained as viewing-related information and delivery of the advertisement being controlled by the delivery control unit on the basis of the obtained viewing-related information and which is obtained by the content display device and is output from the content display device; and a display unit that displays the obtained advertisement.
(18) Another aspect of the present invention is an information processing program causing a computer of an information processing terminal to: obtain an advertisement which is delivered in response to a request from a delivery control unit as a result of information relating to viewing on a content display device being obtained as viewing-related information and delivery of the advertisement being controlled by the delivery control unit on the basis of the obtained viewing-related information and which is obtained by the content display device and is output from the content display device; and display the obtained advertisement.
(19) Another aspect of the present invention is an advertisement delivery method for an advertisement delivery system including an advertisement delivery device and a content display device that displays an advertisement output from the advertisement delivery device, including: obtaining, by the advertisement delivery device, as viewing-related information, information relating to viewing on a content display device; controlling, by the advertisement delivery device using a delivery control unit, delivery of an advertisement on the basis of the obtained viewing-related information; delivering, by the advertisement delivery device, the advertisement in response to a request from the delivery control unit; outputting, by the content display device, the viewing-related information thereof; obtaining, by the content display device, the advertisement delivered from the advertisement delivery device; and displaying, by the content display device, the obtained advertisement.
(20) Another aspect of the present invention is an advertisement delivery method for an advertisement delivery system including an advertisement delivery device, a content display device, and an information processing terminal that displays an advertisement output form the advertisement delivery device, including: obtaining, by the advertisement delivery device, as viewing-related information, information relating to viewing on a content display device; controlling, by the advertisement delivery device using a delivery control unit, delivery of an advertisement on the basis of the obtained viewing-related information; delivering, by the advertisement delivery device, the advertisement in response to a request from the delivery control unit: outputting, by the content display device, the viewing-related information thereof; obtaining, by the content display device, the advertisement delivered from the advertisement delivery device; outputting, by the content display device, the obtained advertisement to the information processing terminal; obtaining, by the information processing terminal, the advertisement from the content display device; and displaying, by the information processing terminal, the obtained advertisement.

### DESCRIPTION OF REFERENCE NUMERALS

1, 1D advertisement delivery system
2, 2D advertisement delivery device
3 content display device
4 information processing terminal
5 advertisement DB server
6 content information server
7 viewing-history information server
21, 31, 41 CPU; 22, 32, 42 storage unit
23, 33, 43 input accepting unit
24, 34, 44 display unit
25, 35, 45 communication unit
26, 36, 46 control unit
261 advertisement obtaining unit
263 first obtaining unit
265 second obtaining unit
266 content information obtaining unit
267 delivery control unit
361 third obtaining unit
363 output control unit
365, 463 display control unit
461 fourth obtaining unit

1. An advertisement delivery device comprising:
a first obtaining unit that obtains viewing-related information indicating a content viewing state on a content display device;
a permission/denial information obtaining unit that obtains permission/denial information associating an advertisement delivery condition with information regarding content; and
a delivery control unit that cancels, on the basis of the permission/denial information and the viewing-related information, delivery of a delivery candidate advertisement if the content is being viewed on the content display device.

2. The advertisement delivery device according to claim 1,
wherein the information regarding content is meta information of the content,
wherein the advertisement delivery device further comprises: a second obtaining unit that obtains meta information of the content displayed on the content display device on the basis of the viewing-related information, and
wherein the delivery control unit controls delivery of the advertisement on the basis of the permission/denial information, the viewing-related information, and the meta information obtained by the second obtaining unit.

3. The advertisement delivery device according to claim 2,
wherein the meta information indicates both or one of a producer of the content and a distributor of the content.

4. The advertisement delivery device according to claim 2,
wherein the meta information indicates a sponsor associated with the content.

5. The advertisement delivery device according to claim 1,
wherein the delivery control unit cancels delivery of the delivery candidate advertisement that is selected on the basis of a piece of viewing-related information that has been updated in a predetermined period out of the viewing-related information.

6. The advertisement delivery device according to claim 1,
wherein the viewing-related information includes, as the information regarding content, information indicating whether the content is displayed on the content display device via an external input terminal or the Internet.

7. The advertisement delivery device according to claim 1,
wherein the viewing-related information includes, as the information regarding content, information indicating whether a user of the content display device is looking away from the content display device, and
wherein the delivery control unit delivers the advertisement to an information processing terminal that functions as a second screen of the content display device, if the user of the content display device is looking away from the content display device.

8. The advertisement delivery device according to claim 1,
wherein the viewing-related information indicates whether a user of the content display devices is out of a room where the content display device is located, and
wherein the display control unit delivers the advertisement to an information processing terminal that functions as a second screen of the content display device, if the user of the content display device is out of the room where the content display device is located.

9. An advertisement delivery method comprising:
obtaining, by an advertisement delivery device, viewing-related information indicating a content viewing state on a content display device;
obtaining, by the advertisement delivery device, permission/denial information associating an advertisement delivery condition with information regarding content; and
cancelling, by the advertisement delivery device, on the basis of the permission/denial information and the viewing-related information, delivery of a delivery candidate advertisement if the content is being viewed on the content display device.

10. An advertisement delivery program causing
a computer of an advertisement delivery device to perform:
a first step of obtaining viewing-related information indicating a viewing state on a content display device;
a second step of obtaining permission/denial information associating an advertisement delivery condition with information regarding content; and
a third step of cancelling, on the basis of the permission/denial information and the viewing-related information, delivery of a delivery candidate advertisement if the content is being viewed on the content display device.

11. An advertisement delivery system comprising: an advertisement delivery device; and a content display device that displays an advertisement delivered from the advertisement delivery device,
the advertisement delivery device including
a first obtaining unit that obtains viewing-related information indicating a viewing state on a content display device,
a permission/denial information obtaining unit that obtains permission/denial information associating an advertisement delivery condition with information regarding content, and
a delivery control unit that cancels, on the basis of the permission/denial information and the viewing-related information, delivery of a delivery candidate advertisement if the content is being viewed on the content display device, and
the content display device including
an output unit that outputs the viewing-related information of the content display device,
a third obtaining unit that obtains an advertisement delivered by the advertisement delivery device without delivery being cancelled, and
a display unit that displays the advertisement obtained by the third obtaining unit.

12. An advertisement delivery system comprising: an advertisement delivery device; a content display device; and an information processing terminal that displays an advertisement output from the advertisement delivery device,
the advertisement delivery device including
a first obtaining unit that obtains viewing-related information indicating a viewing state on a content display device,
a permission/denial information obtaining unit that obtains permission/denial information associating an advertisement delivery condition with information regarding content, and
a delivery control unit that cancels, on the basis of the permission/denial information and the viewing-related information, delivery of a delivery candidate advertisement if the content is being viewed on the content display device, and
the content display device including
a first output unit that outputs the viewing-related information of the content display device,
a third obtaining unit that obtains an advertisement delivered by the advertisement delivery device without delivery being cancelled, and
a second output unit that outputs the advertisement obtained by the third obtaining unit to the information processing terminal, and
the information processing terminal including
a fourth obtaining unit that obtains the advertisement from the content display device, and
a display unit that displays the advertisement obtained by the fourth obtaining unit.

13. A content display device comprising:
a first output unit that outputs viewing-related information indicating a viewing state on the content display device; and
a display unit that displays an advertisement, delivery of which is not cancelled by a delivery control unit that cancels, on the basis of permission/denial information associating an advertisement delivery condition with information regarding content and the viewing-related information output by the first output unit, delivery of a delivery candidate advertisement if the content is being viewed on the content display device.

14. A content display program causing
a computer of a content display device to perform:
a first step of outputting viewing-related information indicating a viewing state on the content display device; and
a second step of displaying an advertisement, delivery of which is not cancelled by a delivery control unit that cancels, on the basis of permission/denial information associating an advertisement delivery condition with information regarding content and the viewing-related information output in the first step, delivery of a delivery candidate advertisement if the content is being viewed on the content display device.

15. An information processing terminal comprising:
a fourth obtaining unit that obtains an advertisement, delivery of which is not cancelled by a delivery control unit that cancels, on the basis of permission/denial information associating an advertisement delivery condition with information regarding content and viewing-related information indicating a viewing state on a content display device, delivery of a delivery candidate advertisement if the content is being viewed on the content display device; and
a display unit that displays the advertisement obtained by the fourth obtaining unit.

16. An information processing program causing
a computer of an information processing terminal to perform:
a first step of obtaining an advertisement, delivery of which is not cancelled by a delivery control unit that cancels, on the basis of permission/denial information associating an advertisement delivery condition with information regarding content and viewing-related information that is information relating to viewing on a content display device, delivery of a delivery candidate advertisement if the content is being viewed on the content display device; and
a second step of displaying the advertisement obtained in the first step.

17. An advertisement delivery method for an advertisement delivery system including an advertisement delivery device and a content display device that displays an advertisement output from the advertisement delivery device, the advertisement delivery method comprising:
obtaining, by the advertisement delivery device, viewing-related information indicating a viewing state on the content display device;
obtaining, by the advertisement delivery device, permission/denial information associating an advertisement delivery condition with information regarding content;
cancelling, by the advertisement delivery device, on the basis of the permission/denial information and the viewing-related information, delivery of a delivery candidate advertisement if the content is being viewed on the content display device;
outputting, by the content display device, the viewing-related information of the content display device;
obtaining, by the content display device, an advertisement delivered by the advertisement delivery device without delivery being cancelled; and
displaying, by the content display device, the obtained advertisement.

18. An advertisement delivery method for an advertisement delivery system including an advertisement delivery device, a content display device, and an information processing terminal that displays an advertisement output from the advertisement delivery device, the advertisement delivery method comprising:
obtaining, by the advertisement delivery device, viewing-related information indicating a viewing state on the content display device;
obtaining, by the advertisement delivery device, permission/denial information associating an advertisement delivery condition with information regarding content;
cancelling, by the advertisement delivery device, on the basis of the permission/denial information and the viewing-related information, delivery of a delivery candidate advertisement if the content is being viewed on the content display device;
outputting, by the content display device, the viewing-related information of the content display device;
obtaining, by the content display device, an advertisement delivered by the advertisement delivery device without delivery being cancelled;
outputting, by the content display device, the obtained advertisement to the information processing terminal;
obtaining, by the information processing terminal, the advertisement from the content display device; and
displaying, by the information processing terminal, the obtained advertisement.

19. The advertisement delivery device according to claim 3,
wherein the meta information indicates a sponsor associated with the content.

20. The advertisement delivery device according to claim 2,
wherein the delivery control unit cancels delivery of the delivery candidate advertisement that is selected on the basis of a piece of viewing-related information that has been updated in a predetermined period out of the viewing-related information.
